(19) United States
(12) Patent Application Publication
(10) Pub. No.: US 2025/0075476 A1
(43) Pub. Date: Mar. 6, 2025

(54) WATER DISCHARGE DEVICE

(71) Applicant: TOTO LTD., Kitakyushu-shi (JP)

(72) Inventors: Tsugumi TANAKA, Kitakyushu-shi (JP); Ryohei YAITA, Kitakyushu-shi (JP)

(73) Assignee: TOTO LTD., Kitakyushu-shi (JP)

(21) Appl. No.: 18/811,142

(22) Filed: Aug. 21, 2024

(30) Foreign Application Priority Data
Aug. 29, 2023 (JP) 2023-138611
Aug. 30, 2023 (JP) 2023-139890

(51) Int. Cl. E03C 1/04; B05B 1/06

(52) U.S. Cl. CPC E03C 1/041; B05B 1/06; E03C 1/0408

(57) ABSTRACT

Object:
To provide a shower device suitable for use during a midday break by setting a temperature of discharged hot water reaching (landing in) a part corresponding to a user's neck (in particular, a back middle portion of the neck) to a relatively low temperature and setting a temperature of discharged hot water reaching (landing in) other areas of the user to a relatively high temperature. Resolution means:
A water discharge device according to the present invention includes a first water discharge unit configured to discharge hot water toward a first discharge range corresponding to a neck of a user who is to be at a predetermined position, and a second water discharge unit configured to discharge hot water toward a second discharge range to the user below the first discharge range, wherein a temperature of the hot water when the hot water reaches the user after having been discharged from the first water discharge unit is lower than a temperature of the hot water when the hot water reaches the user after having been discharged from the second water discharge unit.

### TECHNICAL FIELD

The present invention relates to a water discharge device (e.g., a shower device).

### BACKGROUND ART

In recent years, multifunctional shower devices have been proposed, which are intended to do more than merely clean the body.

Humans perceive temperature differently in different parts of their body. For example, even if they take a shower with hot water of the same temperature, they may feel a difference in the temperature of the hot water in different parts of their body. To address this matter, there is known a shower device that creates a temperature distribution in the discharged hot water by actively changing a particle size of the hot water, thereby making the perceived temperature of the hot water uniform to provide a comfortable mist shower (Patent Document 1).

Specifically, it is proposed to eliminate unevenness in the perceived temperature experienced by the user by actively creating unevenness in the temperature of the discharged hot water through active differentiation in particle (droplet) size between a mist shower sprayed toward the user's chest and a mist shower sprayed toward the user's abdomen.

### CITATION LIST

### Patent Literature

Patent Document 1: JP 2009-189606 A

### SUMMARY OF INVENTION

### Technical Problem

The present inventors have embarked on development of a shower device suitable for use during a midday break. During a midday break, the user desires to comfortably reduce fatigue and pleasantly heighten alertness.

To reduce fatigue, it is necessary to provide a heating effect to improve blood flow. To heighten alertness, it is necessary to provide a heating effect and tactile stimulation that stimulate the sympathetic nerves.

On the other hand, when the user's entire body is subjected to a shower with hot water having a uniform temperature, perspiration is promoted in parts of their body where sweating is likely to occur. Therefore, this type of shower is not suitable for use during a midday break.

In Patent Document 1, unevenness in the temperature of the discharged hot water is created between the hot water sprayed toward the user's chest and the hot water sprayed toward the user's abdomen. However, the present inventors have conducted a series of intensive studies and experiments on the respective optimal temperatures of discharged hot water best suited for different parts of the user's body in view of use during a midday break.

The present inventors have found that, for use during a midday break, it is preferable that the temperature of discharged hot water reaching (landing in) a part corresponding to a user's neck (in particular, a back middle portion of the neck) be set to a relatively low temperature while the temperature of discharged hot water reaching (landing in) other parts of the user' body be set to a relatively high temperature.

One group of aspects of the present invention has been developed on the basis of the above findings. An object of this one group of aspects of the present invention is to provide a shower device suitable for use during a midday break by setting a temperature of discharged hot water reaching (landing in) a part corresponding to a user's neck (in particular, a back middle portion of the neck) to a relatively low temperature and setting a temperature of discharged hot water reaching (landing in) other parts of the user's body to a relatively high temperature.

In addition, in Patent Document 1, the temperature of the mist shower sprayed toward the user's abdomen (a part with less perspiration) is set to a low temperature, which is not effective for warming the user's body while suppressing perspiration.

Furthermore, in Patent Document 1, a flow channel from a hot water supply source to a water discharge unit configured to discharge hot water of a large particle size is shorter than a flow channel from the hot water supply source to another water discharge unit configured to discharge hot water of a small particle size. As a result, if the user mistakenly sets a high temperature, such high-temperature hot water is likely to be discharged toward the user and thus there is a risk that the user may be burned (if hot water of different particle sizes are respectively discharged after having been flown through respective flow channels having the same length, the discharged hot water having a large particle size is subject to a smaller temperature drop, which tends to result in a higher temperature).

Another group of aspects of the present invention has been developed on the basis of the above findings. An object of this other group of aspects of the present invention is to provide a shower device suitable for use during a midday break and mitigating the risk that the user may be burned.

### Solution to Problem

A water discharge device according to the present invention includes a first water discharge unit configured to discharge hot water toward a first discharge range corresponding to a neck of a user who is to be at a predetermined position, and a second water discharge unit configured to discharge hot water toward a second discharge range to the user below the first discharge range. A temperature of the hot water when the hot water reaches the user after having been discharged from the first water discharge unit is lower than a temperature of the hot water when the hot water reaches the user after having been discharged from the second water discharge unit.

According to the present invention, since the temperature of the hot water reaching (landing in) the first discharge range corresponding to the neck of the user is lower than the temperature of the hot water reaching (landing in) the second discharge range below the first discharge range, it is possible to provide a shower device suitable for use during a midday break.

The feature wherein the temperature of the hot water reaching (landing in) the first discharge range corresponding to the neck of the user is relatively lower results in the state that the hot water of the relatively lower temperature reaches the neck (where thick arteries run) and the back immediately below the neck (where more perspiration may generally occur), thereby suppressing perspiration.

On the other hand, by the feature wherein the temperature of the hot water reaching (landing in) the second discharge range below the first discharge range is relatively high, the user can be provided with a comfortable heating effect. That is, it is possible to provide a shower device that can both suppress perspiration and warm the body, and that is suitable for use during a midday break.

For example, the first discharge range may be configured to be variably set (adjustable) to accommodate a height of the user.

Further, it is preferable that the first water discharge unit and the second water discharge unit are disposed facing each other with the predetermined position being located between the first water discharge unit and the second discharge unit.

According to this feature, the second discharge range tends to be toward a part of the body where thermal sensitivity is relatively low (in particular, a front side of the body), making it possible for the user to reliably experience the warming of the body.

Further, it is preferable that the first water discharge unit and the second water discharge unit are configured to discharge hot water such that the hot water is spread out.

According to this feature, since the first water discharge unit and the second water discharge unit are configured to discharge the hot water such that the hot water is spread out, the hot water can be caused to land across a wide area of the body without the necessity of designing a large water discharge port.

Furthermore, it is preferable that an angle formed by a discharge center direction by the first water discharge unit with respect to a vertical direction is larger than an angle formed by a discharge center direction by the second water discharge unit with respect to the vertical direction.

According to this aspect, the hot water from the first water discharge unit is readily locally discharged toward the first discharge range corresponding to the neck of the user, while the hot water from the second water discharge unit is discharged readily spread-out toward the second discharge range below the first discharge range more widely than the discharge water from the first water discharge unit. Therefore, the hot water can be caused to land across a wider area of the body of the user and making it possible for the user to more reliably experience the warming of the body.

Further, it is preferable that the second water discharge unit is configured to discharge the hot water toward a front side, a left side and a right side of the user.

According to this aspect, since the hot water reaches the front side, the left side and the right side of the user, the user can more reliably experience the warming of the body.

Further, it is preferable that the water discharge device further includes an operation unit configured to perform an operational input to the first water discharge unit and/or the second water discharge unit, and the first water discharge unit and the operation unit are disposed facing each other with the predetermined position being located between the first water discharge unit and the operation unit.

According to this aspect, in a state in which the hot water from the first water discharge unit is discharged toward the first discharge range corresponding to the neck of the user, it is easy for the user to view and operate the operation unit. This aspect also makes it possible to prevent the hot water having a relatively low temperature from hitting the face of the user.

Further, it is preferable that the water discharge device further includes a mixing valve connected to a cold water supply pipe and a hot water supply pipe to generate the hot water, a first flow channel portion connecting the mixing valve and the first water discharge unit, and a second flow channel portion connecting the mixing valve and the second water discharge unit, and a particle size of the hot water discharged from the first water discharge unit after having been flown through the first flow channel portion is smaller than a particle size of the hot water discharged from the second water discharge unit after having been flown through the second flow channel portion.

The discharged hot water having a smaller particle size is subject to a greater temperature drop after having been discharged. By utilizing this principle, even in a case in which the mixing valves are integrated into a relatively simple configuration, it is possible to easily realize a state in which the temperature of the hot water reaching (landing in) the first discharge range corresponding to the neck of the user is lower than the temperature of the hot water reaching (landing in) the second discharge range below the first discharge range.

Further, a water discharge device according to a first aspect of another group of aspects of the present invention includes a hot/cold water mixing unit configured to generate hot water of a desired temperature by mixing hot water of a high temperature and cold water, a first water discharge unit configured to discharge hot water toward a user who is to be at a predetermined position, a second water discharge unit provided separately from the first water discharge unit and configured to discharge hot water toward the user who is to be at the predetermined position, a first flow channel portion extending from the hot/cold water mixing unit to the first water discharge unit, and a second flow channel portion extending from the hot/cold water mixing unit to the second water discharge unit, wherein the first flow channel portion and the second flow channel portion branch off from a branch portion provided downstream of the hot/cold water mixing unit, and wherein a particle size of the hot water discharged from the second water discharge unit after having been flown through the second flow channel portion is larger than a particle size of the hot water discharged from the first water discharge unit after having been flown through the first flow channel portion, and wherein a length of the second flow channel portion is longer than a length of the first flow channel portion.

According to the first aspect of this other group of aspects of the present invention, since the length of the second flow channel portion extending from the hot/cold water mixing unit (hot water supply source) to the second water discharge unit configured to discharge the hot water of the large particle size is longer than the length of the first flow channel portion extending from the hot/cold water mixing unit (hot water supply source) to the first water discharge unit configured to discharge the hot water of the small particle size, even if a high temperature is erroneously set, the temperature of the discharged hot water having the large particle size discharged from the second water discharge unit is expected to drop, which can reduce the risk of the user getting burned (expected are a temperature drop due to a thermal conduction (heat dissipation) effect of the longer second flow channel portion itself as well as a temperature drop due to residual hot water (whose temperature tends to be lower) remaining in the longer second flow channel portion).

Further, a water discharge device according to a second aspect of the other group of aspects of the present invention includes a hot/cold water mixing unit configured to generate hot water of a desired temperature by mixing hot water of a high temperature and cold water, a first water discharge unit configured to discharge hot water toward a user who is to be at a predetermined position, a second water discharge unit provided separately from the first water discharge unit and configured to discharge hot water toward the user who is to be at the predetermined position, a first flow channel portion extending from the hot/cold water mixing unit to the first water discharge unit, and a second flow channel portion extending from the hot/cold water mixing unit to the second water discharge unit, wherein the first flow channel portion and the second flow channel portion branch off from a branch portion provided downstream of the hot/cold water mixing unit, and wherein a flow velocity of the hot water discharged from the second water discharge unit after having been flown through the second flow channel portion is lower than a flow velocity of the hot water discharged from the first water discharge unit after having been flown through the first flow channel portion, and wherein a length of the second flow channel portion is longer than a length of the first flow channel portion.

According to the second aspect of this other group of aspects of the present invention, since the length of the second flow channel portion extending from the hot/cold water mixing unit (hot water supply source) to the second water discharge unit configured to discharge the hot water of the low flow velocity is longer than the length of the first flow channel portion from the hot/cold water mixing unit (hot water supply source) to the first water discharge unit configured to discharge the hot water of the high flow velocity, even if a high temperature is erroneously set, the temperature of the discharged hot water having the small flow velocity discharged from the second water discharge unit is expected to drop, which can reduce the risk of the user getting burned (expected are a temperature drop due to a thermal conduction (heat dissipation) effect of the longer second flow channel portion itself as well as a temperature drop due to residual hot water (whose temperature tends to be lower) remaining in the longer second flow channel portion).

A water discharge device according to a third aspect of the other group of aspects of the present invention includes a hot/cold water mixing unit configured to generate hot water of a desired temperature by mixing hot water of a high temperature and cold water, a first water discharge unit configured to discharge hot water toward a user who is to be at a predetermined position, a second water discharge unit provided separately from the first water discharge unit and configured to discharge hot water toward the user who is to be in the predetermined position, a first flow channel portion extending from the hot/cold water mixing unit to the first water discharge unit, a second flow channel portion extending from the hot/cold water mixing unit to the second water discharge unit, and a temperature lowering device provided to actively lower a temperature of the hot water discharged from the first water discharge unit after having been flown through the first flow channel portion, wherein the first flow channel portion and the second flow channel portion branch off from a branch portion provided downstream of the hot/cold water mixing unit, and wherein a length of the second flow channel portion is longer than a length of the first flow channel portion.

According to the third aspect of this other group of aspects of the present invention, since the length of the second flow channel portion extending from the hot/cold water mixing unit (hot water supply source) to the second water discharge unit is longer than the length of the first flow channel portion extending from the hot/cold water mixing unit (hot water supply source) to the first water discharge unit, even if a high temperature is erroneously set, the temperature of the discharged hot water discharged from the second water discharge unit and not passing through the temperature lowering device is expected to drop, which can reduce the risk of the user getting burned (expected are a temperature drop due to a thermal conduction (heat dissipation) effect of the longer second flow channel portion itself as well as a temperature drop due to residual hot water (whose temperature tends to be lower) remaining in the longer second flow channel portion).

In each of the aspects described above, preferably, the first water discharge unit and the second water discharge unit are disposed facing each other with the predetermined position being located between the first water discharge unit and the second water discharge unit, and a discharge range by the second water discharge unit is below a discharge range by the first water discharge unit.

In each of the aspects described above, the hot water discharged by the second water discharge unit tends to have a higher temperature. Herein, by setting the discharge range by the second water discharge unit at a lower position, it is possible to prevent hot water of a high temperature from directly reaching (landing on) the face of the user, regardless of which direction the user faces when using the water discharge device.

Then, when the temperature of the hot water reaching (landing in) the discharge range by the second water discharge unit (which is below the discharge range by the first water discharge unit) is relatively high, the user can also be provided with a comfortable heating effect. That is, it is possible to provide a shower device that can both suppress perspiration and warm the body, and that is suitable for use during a midday break.

The discharge range by the first water discharge unit is preferably a range corresponding to the neck of the user who is to be at the predetermined position and is, for example, a height range from 120 cm to 130 cm (although the setting may be variable (adjustable) to accommodate the height of the user). In this case, as long as the first water discharge unit and the second water discharge unit are disposed facing each other with the predetermined position being located therebetween, the discharge range by the second water discharge unit is a part of the body where thermal sensitivity is relatively low (in particular, a front side of the body), which makes it possible for the user to reliably experience the warming of the body.

Further, preferably, the first water discharge unit is configured to discharge the hot water in a mist form (discharge the hot water in such a manner that it has a small particle size equal to or less than 1 mm).

According to this aspect, even if hot water of a high temperature is discharged on the side of the first water discharge unit where a distance from the hot/cold water mixing unit (hot water supply source) to the first water discharge unit is shorter, heat can be more reliably released into the air until the water lands on the user.

In the event of discharging the hot water in a mist form, if the temperature of the hot water in the vicinity of a water discharge port is, for example, 39.8° C., the temperature of the hot water when reaching (landing on) the body of the user is, for example, about 28.7° C. (relatively low temperature).

Furthermore, preferably, the first water discharge unit and the second water discharge unit are disposed at substantially the same height, and an angle formed by a discharge center direction of the first water discharge unit with respect to a vertical direction is larger than an angle formed by a discharge center direction of the second water discharge unit with respect to the vertical direction.

According to this aspect, the discharged hot water from the second water discharge unit is discharged more readily spread-out below the discharge range by the first water discharge unit more widely than the discharged hot water from the first water discharge unit. Therefore, the hot water can be caused to land across a wider area of the body of the user, making it possible for the user to more reliably experience the warming of the body. Further, even when a high temperature is erroneously set, it is possible to promote a temperature drop of the discharged hot water from the second water discharge unit in the air.

A plurality of second water discharge units may be provided. In this case, one or a plurality of second branch portions may be provided between the plurality of second water discharge units and the branch portion.

In this case, the second flow channel portion(s) branches off from the second branch portion(s), which enhances the thermal conduction (heat dissipation) effect of such a (each) second flow channel portion and makes it possible to further expect a temperature drop due to the (low-temperature) residual hot water remaining in such a (each) second flow channel portion.

### Advantageous Effects of Invention

According to the first group of aspects of the present invention, since the temperature of the hot water reaching (landing in) the first discharge range corresponding to the neck of the user is lower than the temperature of the hot water reaching (landing in) the second discharge range below the first discharge range, it is possible to provide a shower device suitable for use during a midday break. In particular, the feature wherein the temperature of the hot water reaching (landing in) the first discharge range corresponding to the neck of the user is relatively lower results in the state that the hot water of the relatively lower temperature reaches the neck (where thick arteries run) and the back immediately below the neck (where more perspiration may generally occur), thereby suppressing perspiration. On the other hand, by the feature wherein the temperature of the hot water reaching (landing in) the second discharge range below the first discharge range is relatively high, the user can be provided with a comfortable heating effect. That is, it is possible to provide a shower device that can both suppress perspiration and warm the body, and that is suitable for use during a midday break.

According to the first aspect of this other group of aspects of the present invention, since the length of the second flow channel portion extending from the hot/cold water mixing unit (hot water supply source) to the second water discharge unit configured to discharge the hot water of the large particle size is longer than the length of the first flow channel portion extending from the hot/cold water mixing unit (hot water supply source) to the first water discharge unit configured to discharge the hot water of the small particle size, even if a high temperature is erroneously set, the temperature of the discharged hot water having the large particle size discharged from the second water discharge unit is expected to drop, which can reduce the risk of the user getting burned (expected are a temperature drop due to a thermal conduction (heat dissipation) effect of the longer second flow channel portion itself as well as a temperature drop due to residual hot water (whose temperature tends to be lower) remaining in the longer second flow channel portion).

According to the second aspect of this other group of aspects of the present invention, since the length of the second flow channel portion extending from the hot/cold water mixing unit (hot water supply source) to the second water discharge unit configured to discharge the hot water of the low flow velocity is longer than the length of the first flow channel portion from the hot/cold water mixing unit (hot water supply source) to the first water discharge unit configured to discharge the hot water of the high flow velocity, even if a high temperature is erroneously set, the temperature of the discharged hot water having the low flow velocity discharged from the second water discharge unit is expected to drop, which can reduce the risk of the user getting burned (expected are a temperature drop due to a thermal conduction (heat dissipation) effect of the longer second flow channel portion itself as well as a temperature drop due to residual hot water (whose temperature tends to be lower) remaining in the longer second flow channel portion).

According to the third aspect of this other group of aspects of the present invention, since the length of the second flow channel portion extending from the hot/cold water mixing unit (hot water supply source) to the second water discharge unit is longer than the length of the first flow channel portion extending from the hot/cold water mixing unit (hot water supply source) to the first water discharge unit, even if a high temperature is erroneously set, the temperature of the discharged hot water discharged from the second water discharge unit and not passing through the temperature lowering device is expected to drop, which can reduce the risk of the user getting burned (expected are a temperature drop due to a thermal conduction (heat dissipation) effect of the longer second flow channel portion itself as well as a temperature drop due to residual hot water (whose temperature tends to be lower) remaining in the longer second flow channel portion).

### BRIEF DESCRIPTION OF DRAWINGS

FIG. 1 is a schematic view of a shower device according to a first embodiment of the present invention.

FIG. 2 is a schematic view of a shower device according to a modification of the first embodiment of the present invention.

FIG. 3 is a schematic view of a shower device according to an additional modification of the first embodiment of the present invention.

FIG. 4A is a schematic diagram for describing a mode in which a hot/cold water mixing valve is used in common.

FIG. 4B is a schematic diagram for describing another mode in which a hot/cold water mixing valve is used in common.

FIG. 5 is a perspective view illustrating a state in which a shower device according to a second embodiment of the present invention is installed in a shower room.

FIG. 6 is an enlarged cross-sectional view illustrating a shower head main body of the shower device according to the second embodiment of the present invention.

FIG. 7 is a perspective view of a first water discharge unit (sprayer) provided in the shower device according to the second embodiment of the present invention.

FIG. 8 is a cross-sectional view taken along line VIII-VIII of FIG. 7.

FIG. 9 is a cross-sectional view taken along line IX-IX of FIG. 7.

FIG. 10 is a perspective view of a second water discharge unit (sprayer) provided in the shower device according to the second embodiment of the present invention.

FIG. 11 is a partially enlarged cross-sectional view taken along line XI-XI of FIG. 10.

FIG. 12 is a partially enlarged cross-sectional view taken along line XII-XII of FIG. 10.

FIG. 13 is a view schematically illustrating a user taking a shower discharged from the shower head main body of the shower device according to the second embodiment of the present invention.

FIG. 14 is a perspective view illustrating a state in which a user is taking a shower with hot water discharged from a shower device according to a third embodiment of the present invention.

FIG. 15 is a perspective view illustrating a state in which a user is taking a shower with hot water discharged from a shower device according to a fourth embodiment of the present invention.

FIG. 16 is a perspective view illustrating a state in which a user is taking a shower with hot water discharged from a shower device according to a fifth embodiment of the present invention.

FIG. 17 is a schematic view of a shower device according to a sixth embodiment of the present invention.

FIG. 18A is a schematic diagram for describing a mode in which a hot/cold water mixing valve is used in common.

FIG. 18B is a schematic diagram for describing another mode in which a hot/cold water mixing valve is used in common.

FIG. 19 is a schematic view illustrating an arrangement example of a second branch portion in the sixth embodiment of the present invention.

FIG. 20 is a schematic view of the shower device according to a modification of the sixth embodiment of the present invention.

FIG. 21 is a schematic view of the shower device according to an additional modification of the sixth embodiment of the present invention.

FIG. 22A is a schematic view illustrating an arrangement example of the second branch portion in an additional modification of the sixth embodiment of the present invention.

FIG. 22B is a schematic view illustrating another arrangement example of the second branch portion in an additional modification of the sixth embodiment of the present invention.

FIG. 22C is a schematic view illustrating further another arrangement example of the second branch portion in an additional modification of the sixth embodiment of the present invention.

FIG. 23 is a schematic view of a shower device according to a seventh embodiment of the present invention.

FIG. 24 is a schematic view of a shower device according to an eighth embodiment of the present invention.

FIG. 25 is a schematic view illustrating an arrangement example of a branch portion in a ninth embodiment of the present invention.

FIG. 26 is a schematic view illustrating another arrangement example of the branch portion in the ninth embodiment of the present invention.

### DESCRIPTION OF EMBODIMENTS

Hereinafter, embodiments of the present invention will be described with reference to the accompanying drawings.

### Configuration of First Embodiment

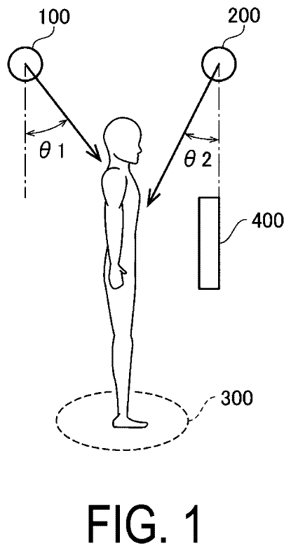

FIG. 1 is a schematic view of a shower device according to a first embodiment of the present invention.

As illustrated in FIG. 1, the shower device of the first embodiment of the present invention includes a first water discharge unit 100 configured to discharge hot water toward a first discharge range corresponding to a neck of a user who is to be at a predetermined position 300, and a second water discharge unit 200 configured to discharge hot water toward a second discharge range to the user below the first discharge range. It should be noted that the term “a predetermined position” as exemplified by the predetermined position 300 is, for example, any position where the first discharge range, which is a discharge range of hot water discharged from the first water discharge unit 100, and the second discharge range, which is a discharge range of hot water discharged from the second water discharge unit 200, intersect with each other in a plan view.

The first discharge range is set to, for example, a height range from 120 cm to 130 cm. However, the first discharge range may be variable (adjustable) to accommodate (fit) the height of the user.

In addition, the first water discharge unit 100 and the second water discharge unit 200 are disposed facing each other with the predetermined position 300 being located therebetween. The first water discharge unit 100 and the second water discharge unit 200 are disposed at substantially the same height. Herein, the term “substantially the same (height)” is defined as a difference in height between the first water discharge unit and the second water discharge unit of within 250 mm.

Each of the first water discharge unit 100 and the second water discharge unit 200 may be fixed and/or installed on a wall surface or a ceiling surface of a shower room via various types of known support members. Alternatively, the first water discharge unit 100 and the second water discharge unit 200 may be directly fixed and/or installed on the wall surface or the ceiling surface of the shower room without the use of any support member.

The first water discharge unit 100 of the present embodiment is configured to discharge the hot water in a mist form, in such a manner that the discharged hot water is spread out into a triangular shape, a solid conical shape, or a hollow conical planar shape. On the other hand, the second water discharge unit 200 of the present embodiment is configured to discharge the hot water in a wave form, in such a manner that the discharged hot water passes through a substantially triangular region. Herein, an angle (θ1: 2 to 90 degrees, for example) formed by a discharge center direction of the first water discharge unit with respect to a vertical direction is larger than an angle (θ2: 1 to 35 degrees, for example) formed by a discharge center direction of the second water discharge unit with respect to the vertical direction.

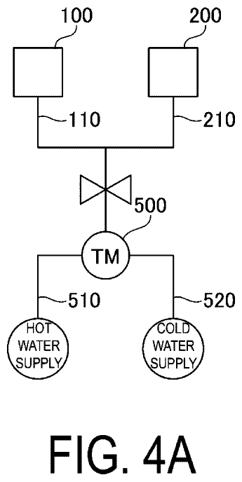

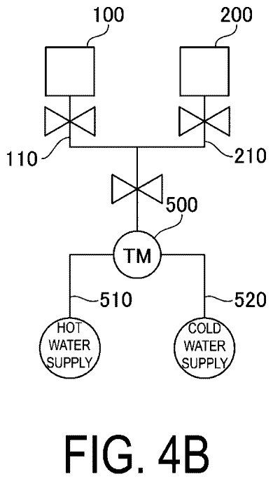

In the present embodiment, the temperature of the hot water immediately after having been discharged from the first water discharge unit 100 and the temperature of the hot water immediately after having been discharged from the second water discharge unit 200 are both 39.8° C. (a hot/cold water mixing valve can be used in common, as described below with reference to FIG. 4A and FIG. 4B). However, the hot water in a mist form discharged from the first water discharge unit 100 has a relatively small particle size and thus exhibits a large progression in temperature drop, and the temperature of the hot water when reaching (landing on) the neck of the user is about 28.7° C. (a relatively low temperature). On the other hand, the hot water in a wave form discharged from the second water discharge unit 200 has a relatively large size and thus exhibits a small progression in temperature drop, and the temperature of the hot water when reaching (landing on) a body part on the front side of the user (below the neck) is about 38.2° C. (a relatively high temperature).

In addition, an operation unit 400 configured to perform an operational input to the first water discharge unit 100 and the second water discharge unit 200 is installed on the wall surface on the same side as the second water discharge unit 200. That is, the first water discharge unit 100 and the operation unit 400 are disposed facing each other with the predetermined position 300 being located therebetween.

### Actions and Effects of First Embodiment

According to the first embodiment, since the temperature of the hot water reaching (landing in) the first discharge range corresponding to the neck of the user is lower than the temperature of the hot water reaching (landing in) the second discharge range below the first discharge range, it is possible to provide a shower device suitable for use during a midday break.

The feature wherein the temperature of the hot water reaching (landing in) the first discharge range corresponding to the neck of the user is relatively lower results in the state that the hot water of the relatively lower temperature reaches the neck (where thick arteries run) and the back immediately below the neck (where more perspiration may generally occur), thereby suppressing perspiration.

On the other hand, by the feature wherein the temperature of the hot water reaching (landing in) the second discharge range below the first discharge range is relatively high, the user can be provided with a comfortable heating effect. That is, it is possible to provide a shower device that can both suppress perspiration and warm the body, and that is suitable for use during a midday break.

Further, the first water discharge unit 100 and the second water discharge unit 200 are disposed facing each other with the predetermined position 300 being located therebetween, that is, the second discharge range tends to be toward a part of the body where thermal sensitivity is relatively low (in particular, the front side of the body), Therefore, the user can more reliably experience warming of the body.

Further, the first water discharge unit 100 and the second water discharge unit 200 are disposed at substantially the same height position, and the discharge center direction of the first water discharge unit 100 has a gentler downward angle than the discharge center direction of the second water discharge unit 200. Therefore, the hot water from the first water discharge unit 100 is readily locally discharged toward the first discharge range corresponding to the neck of the user, while the hot water from the second water discharge unit 200 is discharged readily spread-out toward the second discharge range below the first discharge range more widely than the water discharged from the first water discharge unit 100. Therefore, the hot water can be caused to land across a wider area of the body of the user, and the user can more reliably experience the warming of the body.

Further, since the first water discharge unit 100 and the operation unit 400 are disposed facing each other with the predetermined position 300 being located therebetween, in a state in which the hot water from the first water discharge unit 100 is discharged toward the first discharge range corresponding to the neck of the user, it is easy for the user to view and operate the operation unit 400. This feature also makes it possible to prevent the hot water having a relatively low temperature from hitting the face of the user.

### Modification of First Embodiment

The number of first water discharge units 100 is not limited to one. For example, three first water discharge units 100 may be provided to correspond to the back middle portion of the neck, a back left portion of the neck, and a back right portion of the neck, respectively.

The number of the second water discharge units 200 is also not limited to one. For example, a plurality of second water discharge units 200 may be provided on the front side of the body of the user for the hot water to be discharged toward a wider area on the front side of the body of the user.

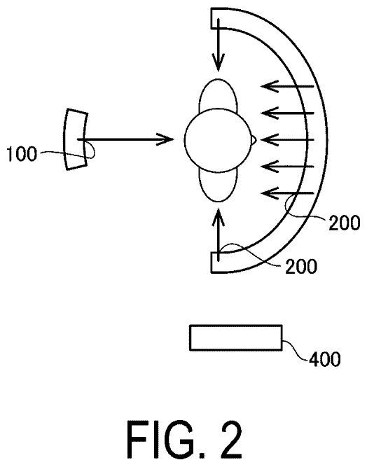

Furthermore, as illustrated in FIG. 2, the second water discharge unit(s) 200 may be configured to discharge the hot water toward a front side, a left side, and a right side of the user. For example, as illustrated in FIG. 2, a plurality of second water discharge units 200 may be provided at appropriate intervals along a water supply passageway disposed in a semi-elliptical shape. According to this aspect, since the hot water reaches the front side, the left side, and the right side of the user, the user can more reliably experience the warming of the body.

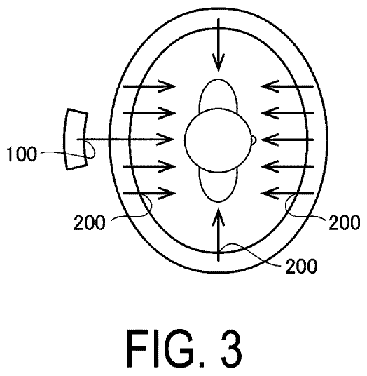

Furthermore, the first water discharge unit(s) 100 and the second water discharge unit(s) 200 can be disposed at different height positions. In this case, as illustrated in FIG. 3, the second water discharge unit(s) 200 may be configured to discharge the hot water over the entire circumference of the user (the front side, the left side, the right side, and the back side). For example, as illustrated in FIG. 3, a plurality of second water discharge units 200 may be provided at appropriate intervals along a water supply passageway disposed in a full elliptical shape. According to this aspect, since the hot water reaches the front side, the left side, the right side, and the back side of the user, the user can more reliably experience the warming of the body.

### Sharing Common Hot/Cold Water Mixing Valve

In the first embodiment, as described above, both the temperature of the hot water immediately after having been discharged from the first water discharge unit 100 and the temperature of the hot water immediately after having been discharged from the second water discharge unit 200 are 39.8° C. Accordingly, the hot water supplied to the first water discharge unit 100 and the hot water supplied to the second water discharge unit 200 can be shared commonly.

That is, as illustrated in FIG. 4A and FIG. 4B, it is possible to adopt a configuration including: a mixing valve 500 connected to a hot water supply pipe 510 and a cold water supply pipe 520 to generate hot water at a desired temperature; a first flow channel portion 110 connecting the mixing valve 500 and the first water discharge unit 100; and a second flow channel portion 210 connecting the mixing valve 500 and the second water discharge unit 200.

In the first embodiment, the particle size of the hot water in a mist form discharged from the first water discharge unit 100 after having been flown through the first flow channel portion 110 is smaller than the particle size of the hot water in a wave form discharged from the second water discharge unit 200 after having been flown through the second flow channel portion 210. Therefore, the temperature of the hot water when reaching (landing on) the neck of the user is about 28.7° C. (relatively low temperature), while the temperature of the hot water when reaching (landing on) a body part on the front side of the user (below the neck) is about 38.2° C. (relatively high temperature).

In the configuration illustrated in FIG. 4A, a flow control valve is provided in an upstream region before the first flow channel portion 110 and the second flow channel portion 210 branch off. In addition to this, in the configuration illustrated in FIG. 4B, two flow control valves are provided along the paths of the first flow channel portion 110 and the second flow channel portion 210, respectively. Either of these configurations can be adopted.

### Configuration of Second Embodiment

Next, a shower device according to a second embodiment of the present invention will be described with reference to the accompanying drawings.

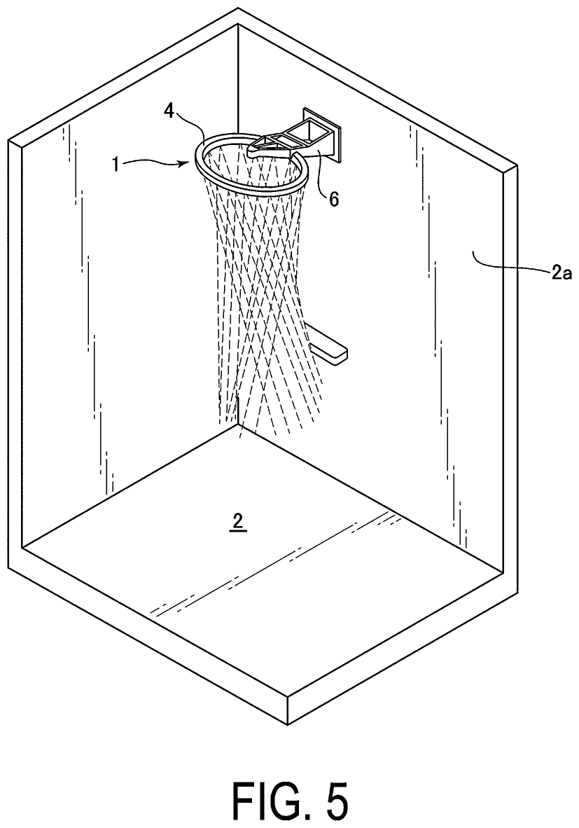

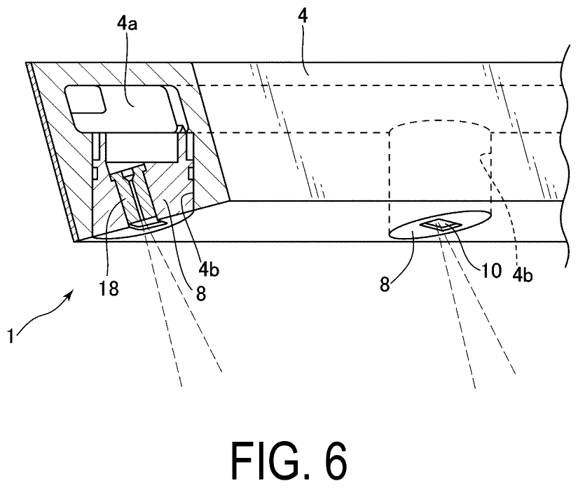

FIG. 5 is a perspective view illustrating a state in which the shower device according to the second embodiment of the present invention is installed in a shower room. FIG. 6 is an enlarged cross-sectional view illustrating a shower head main body of the shower device according to the second embodiment of the present invention.

As illustrated in FIG. 5, the shower device 1 of the present embodiment is fixed to a sidewall surface 2a of the shower room 2. The shower device 1 includes the shower head main body 4, and a support member 6 for attaching the shower head main body 4 to the sidewall surface 2a.

The shower head main body 4 is an annular member having an elliptical shape. A plurality of spraying portions are provided at intervals along the annular member having the elliptical shape.

The support member 6 is a member attached on an upper part of the sidewall surface 2a so as to extend substantially horizontally therefrom, and is configured to support the shower head main body 4 at a predetermined height. Furthermore, a water supply channel (not illustrated) is provided inside the support member 6 in such a manner that hot water supplied through this water supply channel flows into the shower head main body 4 and is discharged from the plurality of spraying portions.

In the present embodiment, the shower head main body 4 is fixed to the sidewall surface 2a via the support member 6 extending substantially horizontally therefrom. However, the shower head main body may be fixed to the ceiling surface via a support member extending (suspended) from the ceiling surface. Further, the shower head main body may be directly fixed to the sidewall surface or the ceiling surface without the use of a support member.

The shower device 1 is configured such that, during use, the hot water is discharged from the plurality of spraying portions and thus a user standing below the shower head main body 4 is showered with the discharged hot water from above. Herein, since the plurality of spraying portions are provided along the annular shower head main body 4, the hot water discharged therefrom forms a shower so as to surround the head of the user standing below the shower head main body 4.

Next, an internal structure of the shower head main body 4 will be described with reference to FIG. 6.

As described above, the shower head main body 4 is formed in an annular configuration having an elliptical shape. A water supply passageway 4a extending along the annular configuration is provided inside the shower head main body 4. The hot water supplied through the water supply channel (not illustrated) formed inside the support member 6 flows into the water supply passageway 4a in the shower head main body 4 to be supplied to the entire shower head main body 4.

Furthermore, the shower head main body 4 is provided with a plurality of sprayer attachment recessed portions 4b at predetermined intervals along the water supply passageway 4a. Each of the sprayer attachment recessed portions 4b is a recess having a hollow cylindrical shape extending in the vertical direction, is formed so as to be in communication with the water supply passageway 4a, and is open toward the lower surface of the shower head main body 4. That is, the hot water flowing through the water supply passageway 4a of the shower head main body 4 flows into the sprayer attachment recessed portions 4b.

A sprayer holding member 8 is fitted in each of the sprayer attachment recessed portions 4b. The sprayer holding member 8 is a member having a substantially solid cylindrical shape and is watertightly fitted in each of the sprayer attachment recessed portions 4b.

A nozzle 18 serving as the spraying portion or the sprayer is held in the sprayer holding member 8, which forms the first water discharge unit of the present invention. The nozzle 18 is held by the sprayer holding member 8 in such a manner that the hot water in a mist form is discharged from a bottom surface of the sprayer holding member 8. Further, the nozzle 18 is held in an obliquely downward orientation by the sprayer holding member 8, and the nozzle 18 is configured to discharge the hot water obliquely downward toward a center axis of the shower head main body 4 having the elliptical shape.

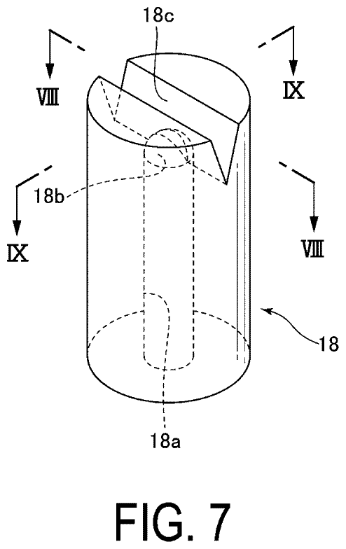

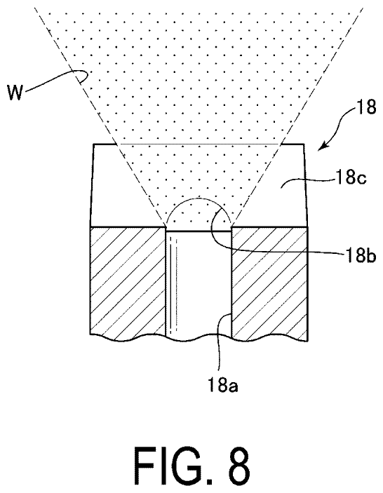

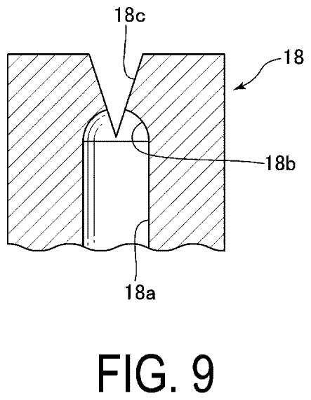

FIG. 7 to FIG. 9 are views illustrating an example of the nozzle 18 for realizing a shower in a mist form, in which hot water falls while being spread out. FIG. 7 is a perspective view illustrating the entire nozzle. FIG. 8 is a partially enlarged cross-sectional view taken along line VIII-VIII of FIG. 7, and FIG. 9 is a partially enlarged cross-sectional view taken along line IX-IX of FIG. 7.

As illustrated in FIG. 7, the nozzle 18 serving as the spraying portion or the sprayer is formed in a substantially cylindrical shape and can be used by being fitted in each of the sprayer attachment recessed portions 4b of the shower head main body 4. As illustrated in FIG. 7 to FIG. 9, a passageway 18a having a circular cross section is formed along a center axis of the cylindrical-shaped nozzle 18. An inner wall surface 18b having a dome shape (hemispherical shape) is formed at an end of the passageway 18a having the circular cross section. Furthermore, a groove 18c having a V-shaped cross section is formed in an end surface of the nozzle 18, and a deepest portion of the groove 18c is formed by cutting out a part of the dome-shaped inner wall surface 18b.

According to this configuration, the hot water guided by the water supply passageway 4a in the shower head main body 4 flows into the passageway 18a of the nozzle 18, and the hot water guided by the passageway 18a flows out from a notch (the cut-out part) of the inner wall surface 18b to a bottom of the groove 18c having the V-shaped cross section, and then the hot water is discharged downward (upward in FIG. 7 to FIG. 9). As a result, as illustrated in FIG. 8, the hot water W discharged from the nozzle 18 falls while being spread out in a mist form in a cone or an elliptical cone shape. In the present embodiment, each nozzle 18 is attached to the shower head main body 4 in such a manner that a major axis of the elliptical cone shape is oriented in a tangential direction of the annular shower head main body 4 having the elliptical shape. Although the shower head main body 4 is provided with the spraying portions (sprayers) by attaching the nozzles 18 to the shower head main body 4 in the present embodiment, it is also possible to provide the shower head main body 4 with the spraying portions (sprayers) by directly forming nozzle holes in a member constituting the shower head main body 4.

In addition, a fluid element 10 serving as the spraying portion or the sprayer is held in the sprayer holding member 8, which forms the second water discharge unit of the present invention. The fluid element 10 is held by the sprayer holding member 8 in such a manner that hot water in a wave form is discharged from the bottom surface of the sprayer holding member 8. Further, the fluid element 10 is held in an obliquely downward orientation by the sprayer holding member 8, and the fluid element 10 is configured to discharge the hot water obliquely downward toward the center axis of the shower head main body 4 having the elliptical shape.

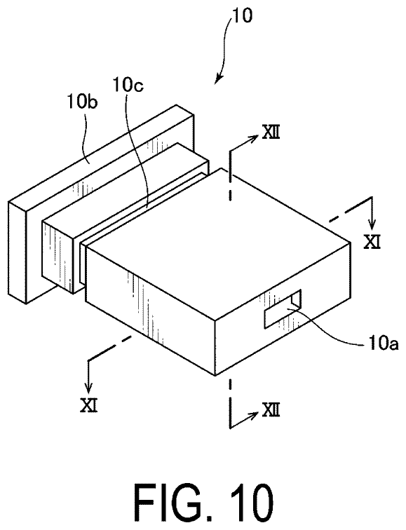

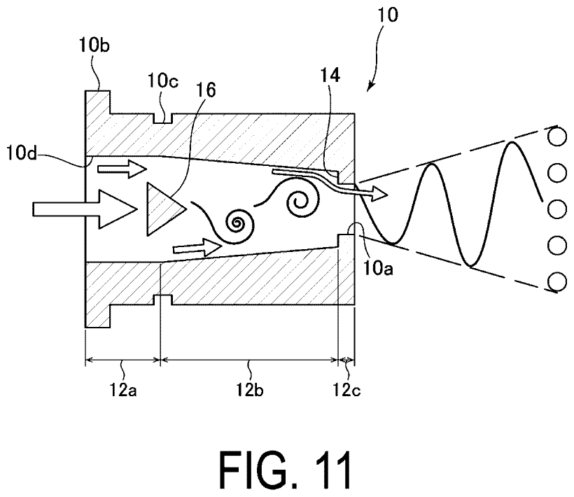

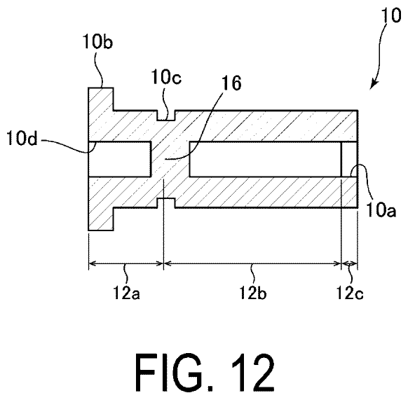

FIG. 10 to FIG. 12 are views illustrating an example of the fluid element 10 for realizing a shower in a wave form, in which hot water falls while being spread out. FIG. 10 is a perspective view of the fluid element 10. FIG. 11 is a cross-sectional view taken along line XI-XI in FIG. 10, and FIG. 12 is a cross-sectional view taken along line XII-XII in FIG. 10.

As illustrated in FIG. 10, the fluid element 10 is a generally thin rectangular parallelepiped member. A water discharge port 10a having a rectangular shape is provided at an end surface on a front surface side of the fluid element 10, and a flange portion 10b is formed at an end portion on a back surface side of the fluid element 10. Furthermore, a groove 10c is formed in parallel with the flange portion 10b, circling around the fluid element 10. An O-ring (not illustrated) is fitted in the groove 10c so as to ensure watertightness with the sprayer holding member 8.

As illustrated in FIG. 11, a passageway having a rectangular cross section is formed inside the fluid element 10, extending through the fluid element 10 in a longitudinal direction. The passageway is formed as a water supply passageway 12a, a vortex street passageway 12b, and a rectification passageway 12c, in this order from an upstream side.

The water supply passageway 12a is a linear passageway extending from an inflow port 10d on the back surface side of the fluid element 10 and having a rectangular cross section with a constant cross-sectional area.

The vortex street passageway 12b is a passageway having a rectangular cross section provided downstream of the water supply passageway 12a so as to be continuous with the water supply passageway 12a (without a step). That is, a downstream end of the water supply passageway 12a and an upstream end of the vortex street passageway 12b have the same size and shape. A pair of opposite wall surfaces (both sidewall surfaces) of the vortex street passageway 12b are configured to be tapered in such a manner that a flow channel cross-sectional area thereof is reduced toward the downstream side over the entire vortex street passageway 12b. That is, the vortex street passageway 12b is configured to have a width that gradually decreases toward the downstream side.

The rectification passageway 12c is a passageway having a rectangular cross section provided on the downstream side so as to be in communication with the vortex street passageway 12b, and is formed linearly with a constant cross-sectional area. The hot water including a vortex street guided by the vortex street passageway 12b is rectified by the rectification passageway 12c, and then is discharged from the water discharge port 10a. A flow channel cross-sectional area of the rectification passageway 12c is configured to be smaller than a flow channel cross-sectional area at a downstream end portion of the vortex street passageway 12b, and thus there is a step portion 14 formed between the vortex street passageway 12b and the rectification passageway 12c. A step portion wall surface that is a front surface of the step portion 14 is oriented in a direction orthogonal to a center axis of the vortex street passageway 12b.

On the other hand, as illustrated in FIG. 12, opposite wall surfaces (ceiling surface and floor surface) of the water supply passageway 12a, the vortex street passageway 12b, and the rectification passageway 12c in a height direction are all provided on the same plane. That is, heights of the water supply passageway 12a, the vortex street passageway 12b, and the rectification passageway 12c are all the same and constant.

Next, a hot water collision portion 16 is formed at a downstream end portion of the water supply passageway 12a (in the vicinity of a connecting portion between the water supply passageway 12a and the vortex street passageway 12b). The hot water collision portion 16 is provided so as to block a part of the water supply passageway 12a at the flow channel cross section. The hot water collision portion 16 is a portion having a triangular prism shape extending so as to couple the opposite wall surfaces (ceiling surface and floor surface) of the water supply passageway 12a facing each other in the height direction, and is disposed like an island at the middle of the water supply passageway 12a in a width direction. A cross section of the hot water collision portion 16 is formed in an isosceles triangle shape, whose oblique side is disposed orthogonal to the center axis of the water supply passageway 12a and whose vertex is disposed facing the downstream side.

Since the hot water collision portion 16 is provided, a Karman vortex is generated on the downstream side thereof, which causes the hot water discharged from the water discharge port 10a to vibrate in a reciprocating manner. That is, the hot water supplied from the water supply channel (not illustrated) of the support member 6 flows into the water supply passageway 4a (FIG. 6) in the shower head main body 4, and further flows into the inflow port 10d of each fluid element 10 held by the corresponding sprayer holding member 8. Then, the hot water flows from the inflow port 10d of each fluid element 10 into the water supply passageway 12a, and collides with the hot water collision portion 16 provided so as to block a part of the flow channel thereof. As a result, a vortex street of alternately counter-rotating Karman vortices is formed on the downstream side of the hot water collision portion 16. The Karman vortex formed by the hot water collision portion 16 grows while being guided by the vortex street passageway 12b tapered toward the downstream, and reaches the rectification passageway 12c.

The hot water flowing into the rectification passageway 12c located downstream of the vortex street passageway 12b is rectified here. The hot water discharged from the water discharge port 10a after having been flown through the rectification passageway 12c is curved on the basis of a flow velocity distribution at the water discharge port 10a, and thus a discharge direction is changed as a portion of the hot water having a high flow velocity moves in the vertical direction in FIG. 11. That is, when a portion of the hot water having a high flow velocity is located at an upper end of the water discharge port 10a in FIG. 11, the hot water is sprayed downward, while when a portion of the hot water having a high flow velocity is located at a lower end of the water discharge port 10a, the hot water is sprayed upward. In this way, as the Karman vortices are alternately generated downstream of the hot water collision portion 16, such a flow velocity distribution is generated at the water discharge port 10a, and thus the sprayed (discharged) flow is deflected. Further, a position of the portion having a high flow velocity moves in a reciprocating manner as the vortex street progresses. Thus, the sprayed hot water also vibrates in a reciprocating manner in a sinusoidal wave shape (in a wave form) substantially within a predetermined vibration plane (plane parallel to the paper surface of FIG. 11).

As illustrated in FIG. 6, in the present embodiment, each fluid element 10 is attached in an obliquely downward orientation, and the hot water discharged from the water discharge port 10a of the fluid element 10 falls while being spread out in a fan-like shape substantially within a predetermined vibration plane. Herein, in the present embodiment, each fluid element 10 is attached to the shower head main body 4 in such a manner that the vibration plane thereof is oriented in the tangential direction (circumferential direction) of the annular shower head main body 4 having the elliptical shape. As a result, as a whole, a shower of hot water like a tubular shape with an elliptical cross section is formed below the shower head main body 4, and the head of the user standing below the shower head main body 4 is surrounded by the shower of hot water.

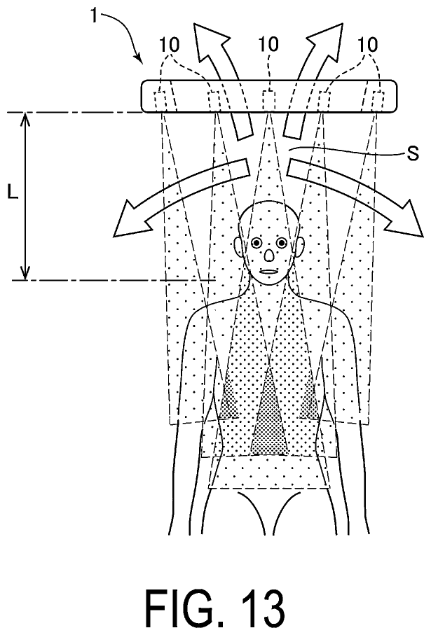

Next, an operation of the shower device 1 according to the second embodiment of the present invention will be described with reference to FIG. 13.

FIG. 13 is a view schematically illustrating a user taking a shower discharged from the shower head main body 4 of the shower device I according to the second embodiment of the present invention.

As described above, the hot water discharged from the nozzles 18 (first water discharge unit) provided in the shower head main body 4 is discharged in a mist form. On the other hand, the hot water discharged from the fluid elements 10 (second water discharge unit) provided in the shower head main body 4 is discharged in a wave form while vibrating in a reciprocating manner in a sinusoidal wave shape. As a result, as illustrated in FIG. 13, the hot water discharged from each nozzle 18 and each fluid element 10 falls while being spread out substantially in a fan-like shape. Further, as described above, each nozzle 18 and each fluid element 10 are attached in an obliquely downward orientation toward the center of the shower head main body 4 (FIG. 6). Therefore, a discharge space S surrounded by the shower of hot water from the respective nozzles 18 and the respective fluid elements 10 has a shape that is tapered downward.

Furthermore, the nozzles 18 and the fluid elements 10 are provided at predetermined intervals along the annular shower head main body 4. Therefore, as illustrated in FIG. 13, in a region where the width of the hot water discharged from each nozzle 18 and each fluid element 10 is not sufficiently wide (region in the vicinity of the shower head main body 4), there are gaps between the hot water discharged from the nozzles 18 and the fluid element 10. This makes it possible for an air in the discharge space S surrounded by the hot water discharged from the nozzles 18 and the fluid elements 10 to flow outward of the discharge space S through the gaps between the discharged hot water. Further, in the present embodiment, since the shower head main body 4 is configured to have an annular shape, the air in the discharge space S is allowed to flow above the shower head main body 4 passing through the inside of the shower head main body 4. Therefore, hot air resulting from the discharged hot water does not stagnate in the discharge space S, and thus the discharge space S is maintained at a comfortable temperature.

On the other hand, the hot water discharged from each nozzle 18 and each fluid element 10 falls while being spread out in a horizontal direction, which causes the discharged hot water to form a flat fan-like shape. The hot water forming a fan-like shape discharged from each nozzle 18 and each fluid element 10 merges at a position where the hot water has fallen by a predetermined distance L. Further, since the hot water forming a flat fan-like shape discharged from each nozzle 18 and each fluid element 10 is directed in the tangential direction of the annular shower head main body 4, the head and the body of the user are surrounded by the hot water forming a fan-like shape discharged from each nozzle 18 and each fluid element 10, and a water film is formed around the body of the user. Therefore, a portion of the discharge space S above the position of the predetermined distance L downward from the shower head main body 4 acts as a hot air releasing space due to the gaps between the shower of hot water. A portion of the discharge space S below the position of the predetermined distance L downward from the shower head main body 4 serves as a hot air holding space due to the hot water discharged from each nozzle 18 and each fluid element 10 merging to form the water film surrounding the body.

Accordingly, the hot water discharged from each nozzle 18 and each fluid element 10 falls by the predetermined distance L, lands on an upper half of the body of the user, and forms a water film so as to cover the body. As a result, the body of the user is sufficiently warmed by the hot water. Therefore, even when the temperature in the shower room 2 is low, the user does not feel cold and can continue to take a shower for a long time.

According to the shower device of the second embodiment of the present invention, since the shower head main body 4 is fixed to the sidewall surface 2a, the user can take a shower without holding the shower head main body 4 with his/her hand. In addition, since the nozzles 18 and the fluid elements 10, which serve as the plurality of spraying portions, are provided at intervals in the shower head main body 4, there are gaps between the hot water discharged from each nozzle 18 and each fluid element 10 in the vicinity of the shower head main body 4. This makes it possible to suppress stagnation of hot air in the discharge space S surrounded by the discharged hot water. As a result, it is possible to help prevent the user from feeling hot or stuffy when the user takes a long shower. Further, since the hot water discharged from each nozzle 18 and each fluid element 10 falls while being spread out, the hot water lands on the body of the user standing below the shower head main body 4 across a wide area, and after landing, the hot water is further spread out on the body surface, making it possible to sufficiently wrap the body with the hot water. As a result, even in a state in which the air temperature is low, the user taking a shower is unlikely to feel cold and can continue taking a shower for a long time.

Further, according to the shower device of the present embodiment, the hot water discharged from each nozzle 18 and each fluid element 10 merges at the position where the hot water has fallen by the predetermined distance L from each nozzle 18 and each fluid element 10 (FIG. 13). Thus, it is possible to ensure air permeability inside and outside the discharge space S surrounded by the discharged hot water up to the position where the hot water merges, and to suppress stagnation of the hot air. Further, below the position where the discharged hot water merges, the body of the user can be sufficiently wrapped with the hot water and thus the body of the user can be sufficiently warmed.

Furthermore, according to the shower device of the present embodiment, since the discharge space S surrounded by the discharged hot water has a shape that is tapered downward, it is possible to ensure air permeability more sufficiently at an upper portion of the discharge space S surrounded by the hot water, while a lower portion of the discharge space S surrounded by the hot water has a smaller volume, which results in case to ensure heat retainability therein to warm the user sufficiently.

Further, according to the shower device of the present embodiment, since the shower head main body 4 has an annular shape, the air in the discharge space S surrounded by the discharged hot water is allowed to flow upward (outside) passing through the inside of the shower head main body 4, which can suppress stagnation of the hot air in the discharge space S surrounded by the discharged hot water.

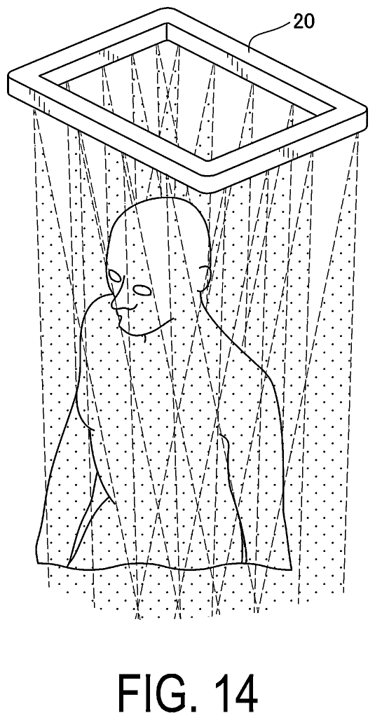

Next, a shower device according to a third embodiment of the present invention will be described with reference to FIG. 14.

In the shower device of the present embodiment, the shape of the shower head main body differs from that of the second embodiment described above. Accordingly, the features of the third embodiment of the present invention that differ from those of the second embodiment will be described, and description of the similar configurations, actions, and effects will be omitted. FIG. 14 is a perspective view illustrating a state in which a user is taking a shower with hot water discharged from the shower device according to the third embodiment of the present invention.

As illustrated in FIG. 14, a shower head main body 20 provided in the shower device according to the third embodiment of the present invention is formed in an annular configuration having a rectangular shape. A plurality of spraying portions are provided along the annular shower head main body 20 having the rectangular shape to form a shower so as to surround the head of the user. The hot water discharged from each spraying portion falls while being spread out in a flat fan-like shape. Further, the hot water falling while being spread out in a fan-like shape is directed in a direction that maintains a parallel relationship with each corresponding side of the shower head main body 20, and merges at a position where the hot water has fallen by a predetermined distance from each spraying portion, and forms a water film around the body of the user. Furthermore, each spraying portion is attached in an obliquely downward orientation in such a manner that the discharged hot water is directed toward the center of the shower head main body 20, and the discharge space surrounded by the shower of hot water has a shape that is tapered downward in a square pyramid. Herein, the nozzle illustrated in FIG. 7 and the fluid element illustrated in FIG. 10 may be employed in an appropriate arrangement as the plurality of spraying portions provided in the shower head main body 20.

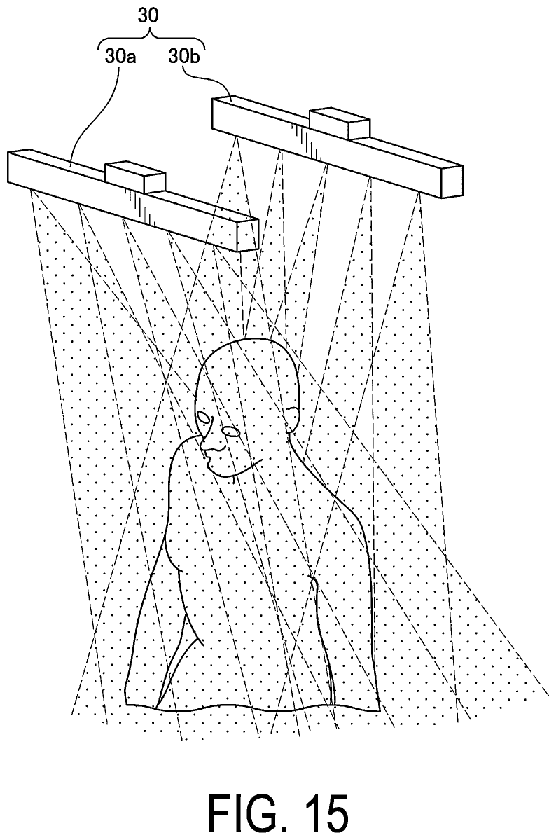

Next, a shower device according to a fourth embodiment of the present invention will be described with reference to FIG. 15.

In the shower device of the present embodiment, the shape of the shower head main body differs from that of the second embodiment described above. Accordingly, the features of the fourth embodiment of the present invention that differ from those of the second embodiment will be described, and description of the similar configurations, actions, and effects will be omitted. FIG. 15 is a perspective view illustrating a state in which a user is taking a shower with hot water discharged from the shower device according to the fourth embodiment of the present invention.

As illustrated in FIG. 15, a shower head main body 30 provided in the shower device according to the fourth embodiment of the present invention consists of two shower head main bodies 30a, 30b, each of which is formed in a linear shape. A plurality of spraying portions are provided along each of the linear shower head main bodies 30a, 30b to form a shower so as to surround the head of the user. The hot water discharged from each spraying portion falls while being spread out in a flat fan-like shape. Furthermore, the spraying portions provided in a middle region of each of the linear shower head main bodies 30a, 30b discharge hot water in a fan-like shape in a direction that maintains a parallel relationship with an extending direction of each of the linear shower head main bodies 30a, 30b. In contrast, the spraying portions provided in the vicinity of both end portions of each of the linear shower head main bodies 30a, 30b discharge hot water in a fan-like shape in a direction substantially at a right angle with respect to the extending direction of each of the linear shower head main bodies 30a, 30b.

Furthermore, the spraying portions provided in each of the linear shower head main bodies 30a, 30b discharge hot water obliquely downward in such a manner that the discharged hot water comes close to each other. Therefore, the discharge space surrounded by the discharged hot water has a shape that is tapered downward. Further, the hot water discharged from each spraying portion provided in the vicinity of the end portions of the shower head main bodies 30a and 30b is directed so as to merge at a position where the hot water has fallen by a predetermined distance. Therefore, as a whole, the hot water discharged from the spraying portions of the two linear shower head main bodies 30a, 30b forms a shower so as to surround the head of the user standing between the two linear shower head main bodies 30a, 30b. Herein, the nozzle exemplified in FIG. 7 and the fluid element exemplified in FIG. 10 may be employed in an appropriate arrangement as the plurality of spraying portions provided in the shower head main body 30.

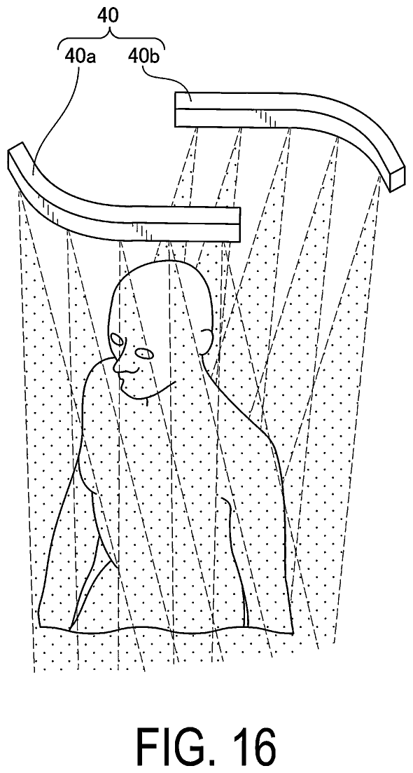

Next, a shower device according to a fifth embodiment of the present invention will be described with reference to FIG. 16.

In the shower device of the present embodiment, the shape of the shower head main body differs from that of the second embodiment described above. Accordingly, the features of the fifth embodiment of the present invention that differ from those of the second embodiment will be described, and description of the similar configurations, actions, and effects will be omitted. FIG. 16 is a perspective view illustrating a state in which a user is taking a shower with hot water discharged from the shower device according to the fifth embodiment of the present invention.

As illustrated in FIG. 16, a shower head main body 40 provided in the shower device according to the fifth embodiment of the present invention consists of two shower head main bodies 40a, 40b, each of which is formed in a curved manner. The shower head main bodies 40a, 40b extend in such a curved manner that opposite end portions thereof come close to each other, and a plurality of spraying portions are provided along each of the curved shower head main bodies 40a, 40b. These spraying portions form a shower so as to surround the head of the user. Here, the hot water discharged from each spraying portion falls while being spread out in a flat fan-like shape. Furthermore, the spraying portions provided in a middle region of each of the curved shower head main bodies 40a, 40b discharge hot water in a fan-like shape in a tangential direction of the curved direction of each of the shower head main bodies 40a, 40b. In contrast, the spraying portions provided in the vicinity of both end portions of each of the curved shower head main bodies 40a, 40b discharge hot water in a fan-like shape at angles close to a right angle with respect to the curved direction of each of the shower head main bodies 40a, 40b.

Furthermore, the spraying portions provided in each of the curved shower head main bodies 40a, 40b discharge hot water obliquely downward in such a manner that the discharged hot water comes close to each other. Therefore, the discharge space surrounded by the discharged hot water has a shape that is tapered downward. Further, the hot water discharged from each spraying portion provided in the vicinity of the end portions of the shower head main bodies 40a and 40b is directed so as to merge at a position where the hot water has fallen by a predetermined distance. Therefore, as a whole. the hot water discharged from the spraying portions of the two curved shower head main bodies 40a, 40b forms a shower so as to surround the head of the user standing between the two curved shower head main bodies 40a, 40b. Herein, the nozzle exemplified in FIG. 7 and the fluid element exemplified in FIG. 10 may be employed in an appropriate arrangement as the plurality of spraying portions provided in the shower head main body 40.

In each of the embodiments described above, the particle size of the hot water discharged from the first water discharge unit after having been flown through the first flow channel portion is smaller than the particle size of the hot water discharged from the second water discharge unit after having been flown through the second flow channel portion in such a manner that the temperature of the hot water when reaching the user after having been discharged from the first water discharge unit is lower than the temperature of the hot water when reaching the user after having been discharged from the second water discharge unit. However, the present invention is not limited to this configuration. For example, another configuration may be adopted in which the temperature of the hot water when reaching the user after having been discharged from the first water discharge unit is set lower than the temperature of the hot water when reaching the user after having been discharged from the second water discharge unit by directly setting the temperature of the hot water when discharged from the first water discharge unit lower than the temperature of the hot water when discharged from the second water discharge unit.

Note that the present invention includes the following features (inventions).

### Feature 1

A water discharge device including:
a first water discharge unit configured to discharge hot water toward a first discharge range corresponding to a neck of a user who is to be at a predetermined position; and
a second water discharge unit configured to discharge hot water toward a second discharge range to the user below the first discharge range, wherein
a temperature of the hot water when the hot water reaches the user after having been discharged from the first water discharge unit is lower than a temperature of the hot water when the hot water reaches the user after having been discharged from the second water discharge unit.

### Feature 2

The water discharge device according to feature 1, wherein
the first discharge range is configured to be variably set to accommodate a height of the user.

### Feature 3

The water discharge device according to feature 1 or 2, wherein
the first water discharge unit and the second water discharge unit are disposed facing each other with the predetermined position being located between the first water discharge unit and the second water discharge unit.

### Feature 4

The water discharge device according to any one of features 1 to 3, wherein
the first water discharge unit and the second water discharge unit are configured to discharge hot water such that the hot water is spread out.

### Feature 5

The water discharge device according to any one of features 1 to 4, wherein
an angle formed by a discharge center direction of the first water discharge unit with respect to a vertical direction is larger than an angle formed by a discharge center direction of the second water discharge unit with respect to the vertical direction.

### Feature 6

The water discharge device according to any one of features 1 to 5, wherein
the second water discharge unit is configured to discharge the hot water toward a front side, a left side, and a right side of the user.

### Feature 7

The water discharge device according to any one of features 1 to 6, further including:
an operation unit configured to perform an operational input to the first water discharge unit and/or the second water discharge unit, wherein
the first water discharge unit and the operation unit are disposed facing each other with the predetermined position being located between the first water discharge unit and the operation unit.

### Feature 8

The water discharge device according to any one of features 1 to 7, further including:
a mixing valve connected to a cold water supply pipe and a hot water supply pipe to generate the hot water;
a first flow channel portion connecting the mixing valve and the first water discharge unit; and
a second flow channel portion connecting the mixing valve and the second water discharge unit, wherein
a particle size of the hot water discharged from the first water discharge unit after having been flown through the first flow channel is smaller than a particle size of the hot water discharged from the second water discharge unit after having been flown through the second flow channel.

Next, embodiments of another group of aspects of the present invention will be described. Constituent elements and portions that are the same as (common to) those in the embodiments of the first group of aspects of the present invention described above will be denoted using the same reference signs. When the configuration includes common content, reference will be made to the same drawings.

### Configuration of Sixth Embodiment

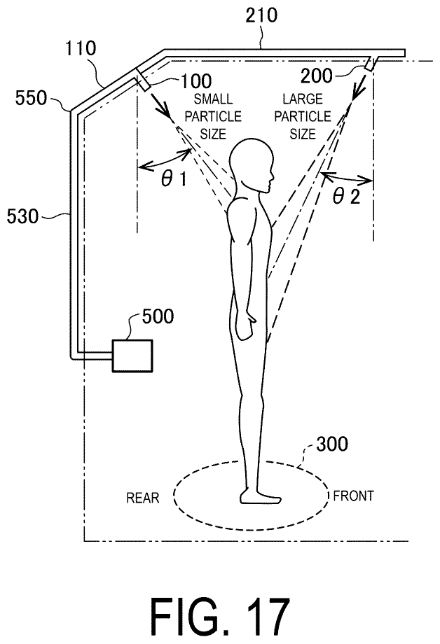

FIG. 17 is a schematic view of a shower device according to a sixth embodiment of the present invention.

As illustrated in FIG. 17, the shower device of the sixth embodiment of the present invention includes a first water discharge unit 100 configured to discharge hot water toward a first discharge range corresponding to a neck of a user who is to be at a predetermined position 300, and a second water discharge unit 200 configured to discharge hot water toward a second discharge range to the user below the first discharge range. It should be noted that the term “a predetermined position” as exemplified by the predetermined position 300 is, for example, any position where the first discharge range, which is a discharge range of hot water discharged from the first water discharge unit 100, and the second discharge range, which is a discharge range of hot water discharged from the second water discharge unit 200, intersect with each other in a plan view.

The first discharge range is set to, for example, a height range from 120 cm to 130 cm. However, the first discharge range may be variable (adjustable) to accommodate (fit) the height of the user.

In addition, the first water discharge unit 100 and the second water discharge unit 200 are disposed facing each other with the predetermined position 300 being located therebetween. The first water discharge unit 100 and the second water discharge unit 200 are disposed at substantially the same height. Herein, the term “substantially the same (height)” is defined as a difference in height between the first water discharge unit and the second water discharge unit of within 250 mm.

Each of the first water discharge unit 100 and the second water discharge unit 200 may be fixed and/or installed on a wall surface or a ceiling surface of a shower room via various types of known support members. Alternatively, the first water discharge unit 100 and the second water discharge unit 200 may be directly fixed and/or installed on the wall surface or the ceiling surface of the shower room without the use of any support member.

The first water discharge unit 100 of the present embodiment is configured to discharge the hot water in a mist form, in such a manner that the discharged hot water is spread out into a triangular shape, a solid conical shape, or a hollow conical planar shape. On the other hand, the second water discharge unit 200 of the present embodiment is configured to discharge the hot water in a wave form, in such a manner that the discharged hot water passes through a substantially triangular region. Herein, an angle (θ1: 2 to 90 degrees, for example) formed by a discharge center direction of the first water discharge unit with respect to a vertical direction is larger than an angle (θ2: 1 to 35 degrees, for example) formed by a discharge center direction of the second water discharge unit with respect to the vertical direction.

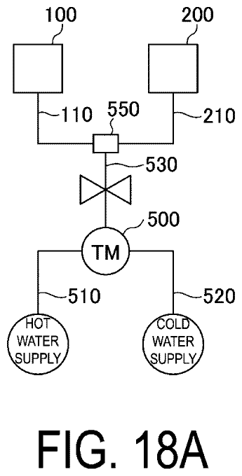

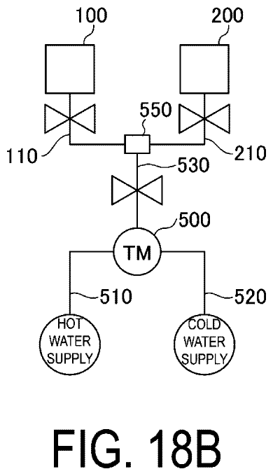

In the present embodiment, the temperature of the hot water immediately after having been discharged from the first water discharge unit 100 and the temperature of the hot water immediately after having been discharged from the second water discharge unit 200 are both 39.8° C. during stable supply thereof. Thus, a hot/cold water mixing valve 500 can be used in common, as described below with reference to FIG. 18A and FIG. 18B. However, the hot water in a mist form discharged from the first water discharge unit 100 has a relatively small particle size and thus exhibits a large progression in temperature drop, and the temperature of the hot water when reaching (landing on) the neck of the user is about 28.7° C. (a relatively low temperature). On the other hand, the hot water in a wave form discharged from the second water discharge unit 200 has a relatively large size and thus exhibits a small progression in temperature drop, and the temperature of the hot water when reaching (landing on) a body part on the front side of the user (below the neck) is about 38.2° C. (a relatively high temperature).

In the present embodiment, as illustrated in FIG. 18A and FIG. 18B, it is possible to adopt a configuration including: a mixing valve 500 connected to a hot water supply pipe 510 and a cold water supply pipe 520 to generate hot water at a desired temperature; a first flow channel portion 110 connecting the mixing valve 500 and the first water discharge unit 100; and a second flow channel portion 210 connecting the mixing valve 500 and the second water discharge unit 200. (In the configuration illustrated in FIG. 18A, a flow control valve is provided in an upstream region before the first flow channel portion 110 and the second flow channel portion 210 branch off. In addition to this, in the configuration illustrated in FIG. 18B, two flow control valves are provided along the paths of the first flow channel portion 110 and the second flow channel portion 210, respectively. Either of these configurations can be adopted.)

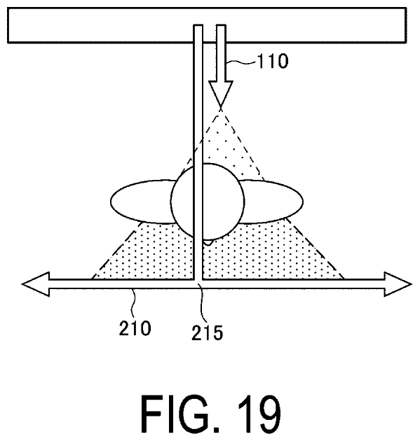

Further, in the present embodiment, the first flow channel portion 110 and the second flow channel portion 210 include the common portion 530 on the hot/cold water mixing valve 500 side, and branch at a branch (bifurcation) portion 550 (see FIG. 18A and FIG. 18B). Further, a plurality of the second water discharge units 200 may be provided, and one or more second branch portions 215 may be provided between the plurality of second water discharge units 200 and the branch portion 550. For example, as illustrated in FIG. 19, the second flow channel portion 210 spanning the plurality of second water discharge units 200 can adopt a substantially T-shaped configuration in a plan view including one second branch portion 215.

Furthermore, in the present embodiment, the length of the second flow channel portion 210 extending from the hot/cold water mixing valve 500 to the second water discharge unit 200 is longer than the length of the first flow channel portion 110 extending from the hot/cold water mixing valve 500 to the first water discharge unit 100 (see FIG. 17 and FIG. 19).

### Actions and Effects of Sixth Embodiment

According to the sixth embodiment, since the temperature of the hot water reaching (landing in) the first discharge range corresponding to the neck of the user is lower than the temperature of the hot water reaching (landing in) the second discharge range below the first discharge range, it is possible to provide a shower device suitable for use during a midday break.

The feature wherein the temperature of the hot water reaching (landing in) the first discharge range corresponding to the neck of the user is relatively lower results in the state that the hot water of the relatively lower temperature reaches the neck (where thick arteries run) and the back immediately below the neck (where more perspiration may generally occur), thereby suppressing perspiration.

On the other hand, by the feature wherein the temperature of the hot water reaching (landing in) the second discharge range below the first discharge range is relatively high, the user can be provided with a comfortable heating effect. That is, it is possible to provide a shower device that can both suppress perspiration and warm the body, and that is suitable for use during a midday break.

Further, the first water discharge unit 100 and the second water discharge unit 200 are disposed facing each other with the predetermined position 300 being located therebetween, that is, the second discharge range tends to be toward a part of the body where thermal sensitivity is relatively low (in particular, the front side of the body). Therefore, the user can more reliably experience warming of the body.

Further, the first water discharge unit 100 and the second water discharge unit 200 are disposed at substantially the same height position, and the discharge center direction of the first water discharge unit 100 has a gentler downward angle than the discharge center direction of the second water discharge unit 200. Therefore, the hot water from the first water discharge unit 100 is readily locally discharged toward the first discharge range corresponding to the neck of the user, while the hot water from the second water discharge unit 200 is discharged readily spread-out toward the second discharge range below the first discharge range more widely than the water discharged from the first water discharge unit 100. Therefore, the hot water can be caused to land across a wider area of the body of the user, and the user can more reliably experience the warming of the body. Further, even when a high temperature is erroneously set, it is possible to promote a temperature drop of the discharged hot water from the second water discharge unit 200 in the air.

Further, the length of the second flow channel portion 210 extending from the mixing valve 500 to the second water discharge unit 200 is longer than the length of the first flow channel portion 110 extending from the mixing valve 500 to the first water discharge unit 100. Thus, even if a high temperature is erroneously set, the temperature of the discharged hot water having a large particle size discharged from the second water discharge unit 200 is expected to drop, which can reduce the risk of the user getting burned (expected are a temperature drop due to a thermal conduction (heat dissipation) effect of the longer second flow channel portion 210 itself as well as a temperature drop due to residual hot water (whose temperature tends to be lower) remaining in the longer second flow channel portion 210). Specifically, when hot water is started to be supplied in a setting in which the temperature thereof is 50° C., as long as the temperature of the residual hot water is about 25° C. (about room temperature), the temperature of the hot water immediately after having been discharged % dropped to about 40° C. even if the temperature of the hot water immediately after having been discharged from the first water discharge unit 100 is as high as about 44° C.

### Modification of Sixth Embodiment

The number of first water discharge units 100 is not limited to one. For example, three first water discharge units 100 may be provided to correspond to the back middle portion of the neck, a back left portion of the neck, and a back right portion of the neck, respectively. The number of the second water discharge units 200 is also not limited to one. For example, as illustrated in FIG. 19, a plurality of second water discharge units 200 may be provided on the front side of the body of the user for the hot water to be discharged toward a wider area on the front side of the body of the user.

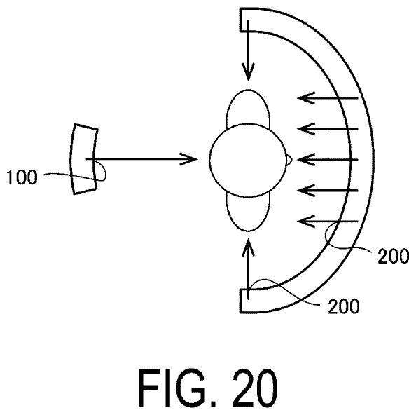

Furthermore, as illustrated in FIG. 20, the second water discharge unit(s) 200 may be configured to discharge the hot water toward a front side, a left side, and a right side of the user. For example, as illustrated in FIG. 20, a plurality of second water discharge units 200 may be provided at appropriate intervals along a water supply passageway disposed in a semi-elliptical shape. According to this aspect, since the hot water reaches the front side, the left side, and the right side of the user, the user can more reliably experience the warming of the body.

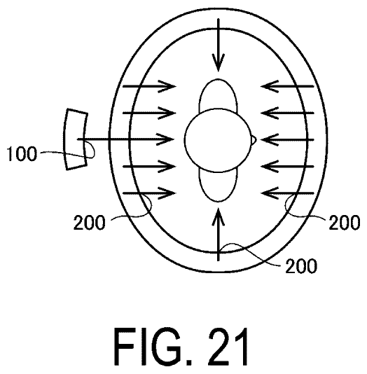

Furthermore, the first water discharge unit(s) 100 and the second water discharge unit(s) 200 can be disposed at different height positions. In this case, as illustrated in FIG. 21, the second water discharge unit(s) 200 may be configured to discharge the hot water over the entire circumference of the user (the front side, the left side, the right side, and the back side). For example, as illustrated in FIG. 21, a plurality of second water discharge units 200 may be provided at appropriate intervals along a water supply passageway disposed in a full elliptical shape. According to this aspect, since the hot water reaches the front side, the left side, the right side, and the back side of the user, the user can more reliably experience the warming of the body.

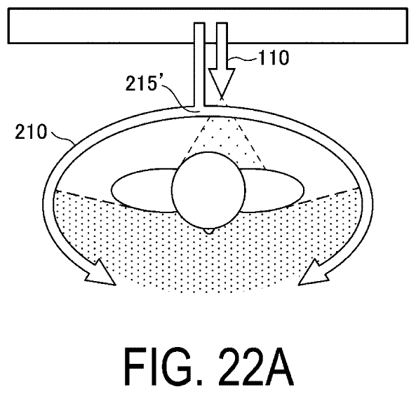

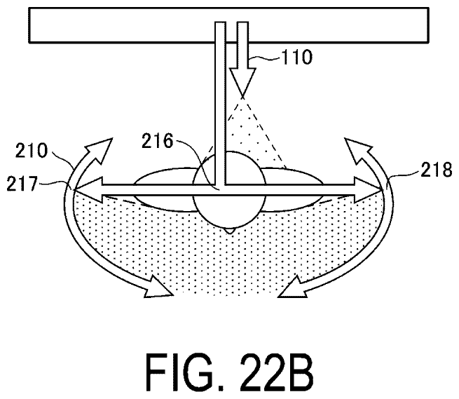

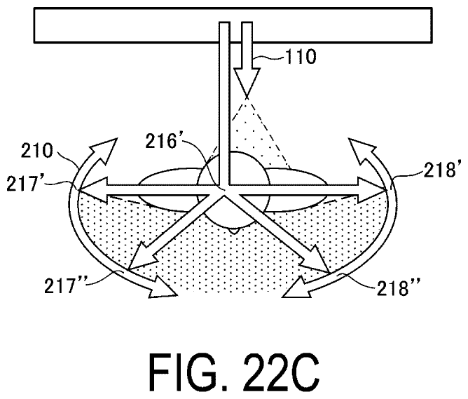

Further, in this case, as illustrated in FIG. 22A, the second flow channel portion 210 spanning the plurality of second water discharge units 200 may adopt the shape of a Japanese map symbol for a fire station (a vertical line whose top end is connected to a bottom of an upwardly open semicircle) in a plan view including one second branch portion 215′.

Alternatively, in this case, as illustrated in FIG. 22B and FIG. 22C, the second flow channel portion 210 spanning the plurality of second water discharge units 200 may include a second branch portion 216, 216′, at which a plurality of flow channels radially branch off above the head of the user, and third branch portions 217, 218, 217′, 218′, 217″, 218″, at which each radially branched flow channel is further branched in both directions of a common (shared) annular configuration.

### Configuration of Seventh Embodiment

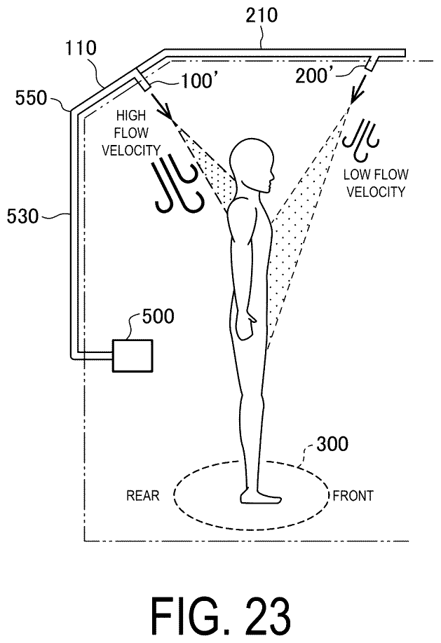

FIG. 23 is a schematic view of a shower device according to a seventh embodiment of the present invention.

As illustrated in FIG. 23, the shower device of the seventh embodiment of the present invention includes a first water discharge unit 100′ configured to discharge hot water toward a first discharge range corresponding to a neck of a user who is to be at a predetermined position 300, and a second water discharge unit 200′ configured to discharge hot water toward a second discharge range to the user below the first discharge range.

As in the sixth embodiment, the first discharge range is set to, for example, a height range from 120 cm to 130 cm. However, the first discharge range may be variable (adjustable) to accommodate (fit) the height of the user.

In addition, as in the sixth embodiment, the first water discharge unit 100′ and the second water discharge unit 200′ are disposed facing each other with the predetermined position 300 being located therebetween. The first water discharge unit 100′ and the second water discharge unit 200′ are disposed at substantially the same height.

In addition, as in the sixth embodiment, each of the first water discharge unit 100′ and the second water discharge unit 200′ may be fixed and/or installed on a wall surface or a ceiling surface of a shower room via various types of known support members. Alternatively, the first water discharge unit 100′ and the second water discharge unit 200′ may be directly fixed and/or installed on the wall surface or the ceiling surface of the shower room without the use of any support member.

The first water discharge unit 100′ of the present embodiment is a shower type of water discharge unit with openings each of which has a relatively small diameter, and is configured to discharge hot water in a shower form at a relatively high flow velocity (e.g., 2.0 m/s to 8.0 m/s). On the other hand, the second water discharge unit 200′ of the present embodiment is also a shower type of water discharge unit with openings each of which has a relatively large diameter, and is configured to discharge hot water in a shower form at a relatively low flow velocity (e.g., 1.0 m/s to 4.0 m/s). Herein, an angle (θ1: 2 to 90 degrees, for example) formed by a discharge center direction of the first water discharge unit 100′ with respect to a vertical direction is larger than an angle (θ2: 1 to 35 degrees, for example) formed by a discharge center direction of the second water discharge unit 200′ with respect to the vertical direction.

In the present embodiment as well, the temperature of the hot water immediately after having been discharged from the first water discharge unit 100′ and the temperature of the hot water immediately after having been discharged from the second water discharge unit 200′ are both 39.8° C. during stable supply thereof. Thus, a hot/cold water mixing valve 500 can be used in common, as described with reference to FIG. 18A and FIG. 18B. However, the hot water in a shower form discharged from the first water discharge unit 100′ has a relatively high flow velocity and thus exhibits a large progression in temperature drop, and the temperature of the hot water when reaching (landing on) the neck of the user is about 28.7° C. (a relatively low temperature). On the other hand, the hot water in a shower form discharged from the second water discharge unit 200′ has a relatively low flow velocity and thus exhibits a small progression in temperature drop, and the temperature of the hot water when reaching (landing on) a body part on the front side of the user (below the neck) is about 38.2° C. (a relatively high temperature).

In the present embodiment as well, as illustrated in FIG. 18A and FIG. 18B, it is possible to adopt a configuration including: a mixing valve 500 connected to a hot water supply pipe 510 and a cold water supply pipe 520 to generate hot water at a desired temperature; a first flow channel portion 110 connecting the mixing valve 500 and the first water discharge unit 100′; and a second flow channel portion 210 connecting the mixing valve 500 and the second water discharge unit 200′.

Further, in the present embodiment as well, the first flow channel portion 110 and the second flow channel portion 210 include the common portion 530 on the hot/cold water mixing valve 500 side, and branch at a branch (bifurcation) portion 550 (see FIG. 18A and FIG. 18B). Further, a plurality of the second water discharge units 200′ may be provided, and one or more second branch portions 215 may be provided between the plurality of second water discharge units 200′ and the branch portion 550. For example, as illustrated in FIG. 19, the second flow channel portion 210 spanning the plurality of second water discharge units 200′ can adopt a substantially T-shaped configuration in a plan view including one second branch portion 215.

Furthermore, in the present embodiment, the length of the second flow channel portion 210 extending from the hot/cold water mixing valve 500 to the second water discharge unit 200′ is longer than the length of the first flow channel portion 110 extending from the hot/cold water mixing valve 500 to the first water discharge unit 100′ (see FIG. 23 and FIG. 19).

### Actions and Effects of Seventh Embodiment

According to the seventh embodiment, substantially the same actions and effects as those achieved by the sixth embodiment can be achieved. That is, since the temperature of the hot water reaching (landing in) the first discharge range corresponding to the neck of the user is lower than the temperature of the hot water reaching (landing in) the second discharge range below the first discharge range, it is possible to provide a shower device suitable for use during a midday break. In addition, the feature wherein the temperature of the hot water reaching (landing in) the first discharge range corresponding to the neck of the user is relatively lower results in the state that the hot water of the relatively lower temperature reaches the neck (where thick arteries run) and the back immediately below the neck (where more perspiration may generally occur), thereby suppressing perspiration. On the other hand, by the feature wherein the temperature of the hot water reaching (landing in) the second discharge range below the first discharge range is relatively high, the user can be provided with a comfortable heating effect. That is, it is possible to provide a shower device that can both suppress perspiration and warm the body, and that is suitable for use during a midday break.

Further, the first water discharge unit 100′ and the second water discharge unit 200′ are disposed facing each other with the predetermined position 300 being located therebetween, that is, the second discharge range tends to be toward a part of the body where thermal sensitivity is relatively low (in particular, the front side of the body). Therefore, the user can more reliably experience warming of the body. Further, the first water discharge unit 100′ and the second water discharge unit 200′ are disposed at substantially the same height position, and the discharge center direction of the first water discharge unit 100′ has a gentler downward angle than the discharge center direction of the second water discharge unit 200′. Therefore, the hot water from the first water discharge unit 100′ is readily locally discharged toward the first discharge range corresponding to the neck of the user, while the hot water from the second water discharge unit 200′ is discharged readily spread-out toward the second discharge range below the first discharge range more widely than the water discharged from the first water discharge unit 100′. Therefore, the hot water can be caused to land across a wider area of the body of the user, and the user can more reliably experience the warming of the body. Further, even when a high temperature is erroneously set, it is possible to promote a temperature drop of the discharged hot water from the second water discharge unit 200′ in the air.

Further, the length of the second flow channel portion 210 extending from the mixing valve 500 to the second water discharge unit 200′ is longer than the length of the first flow channel portion 110 extending from the mixing valve 500 to the first water discharge unit 100′. Thus, even if a high temperature is erroneously set, the temperature of the discharged hot water having a low flow velocity discharged from the second water discharge unit 200′ is expected to drop, which can reduce the risk of the user getting burned (expected are a temperature drop due to a thermal conduction (heat dissipation) effect of the longer second flow channel portion 210 itself as well as a temperature drop due to residual hot water (whose temperature tends to be lower) remaining in the longer second flow channel portion 210). Specifically, when hot water is started to be supplied in a setting in which the temperature thereof is 50° C., as long as the temperature of the residual hot water is about 25° C. (about room temperature), the temperature of the hot water immediately after having been discharged from the second water discharge unit 200′ is dropped to about 40° C. even if the temperature of the hot water immediately after having been discharged from the first water discharge unit 100′ is as high as about 44° C.

### Configuration of Eighth Embodiment

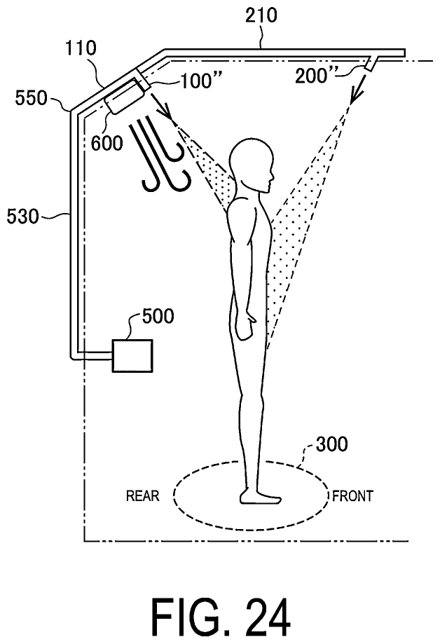

FIG. 24 is a schematic view of a shower device according to an eighth embodiment of the present invention.

As illustrated in FIG. 24, the shower device of the eighth embodiment of the present invention includes a first water discharge unit 100″ configured to discharge hot water toward a first discharge range corresponding to a neck of a user who is to be at a predetermined position 300, and a second water discharge unit 200″ configured to discharge hot water toward a second discharge range to the user below the first discharge range.

As in the sixth and seventh embodiments, the first discharge range is set to, for example, a height range from 120 cm to 130 cm. However, the first discharge range may be variable (adjustable) to accommodate (fit) the height of the user.

In addition, as in the sixth and seventh embodiments, the first water discharge unit 100″ and the second water discharge unit 200″ are disposed facing each other with the predetermined position 300 being located therebetween. The first water discharge unit 100″ and the second water discharge unit 200″ are disposed at substantially the same height.

In addition, as in the sixth and seventh embodiments, each of the first water discharge unit 100″ and the second water discharge unit 200″ may be fixed and/or installed on a wall surface or a ceiling surface of a shower room via various types of known support members. Alternatively, the first water discharge unit 100″ and the second water discharge unit 200″ may be directly fixed and/or installed on the wall surface or the ceiling surface of the shower room without the use of any support member.

The first water discharge unit 100″ of the present embodiment is configured to discharge the hot water in a wave form, in such a manner that the discharged hot water passes through a substantially triangular region. A fan device 600 (an example of a temperature lowering device) is provided in the vicinity of the first water discharge unit 100″ to actively lower the temperature of the hot water immediately after having been discharged from the first water discharge unit 100″ (which makes it possible to lower the temperature by approximately the same extent as that of the hot water discharged in a mist form). On the other hand, the second water discharge unit 200″ of the present embodiment is configured to discharge the hot water in a wave form, in such a manner that the discharged hot water passes through a substantially triangular region. Herein, an angle (θ1: 2 to 90 degrees, for example) formed by a discharge center direction of the first water discharge unit 100″ with respect to a vertical direction is larger than an angle (θ2: 1 to 35 degrees, for example) formed by a discharge center direction of the second water discharge unit 200″ with respect to the vertical direction.

In the present embodiment as well, the temperature of the hot water immediately after having been discharged from the first water discharge unit 100″ and the temperature of the hot water immediately after having been discharged from the second water discharge unit 200″ are both 39.8° C. during stable supply thereof. Thus, a hot/cold water mixing valve 500 can be used in common, as described with reference to FIG. 18A and FIG. 18B. However, the hot water in a wave form discharged from the first water discharge unit 100″ is subjected to actions of the fan device 600 and thus exhibits a large progression in temperature drop, and the temperature of the hot water when reaching (landing on) the neck of the user is about 28.7° C. (a relatively low temperature). On the other hand, the hot water in a wave form discharged from the second water discharge unit 200″ has a relatively low flow velocity and thus exhibits a small progression in temperature drop, and the temperature of the hot water when reaching (landing on) a body part on the front side of the user (below the neck) is about 38.2° C. (a relatively high temperature).

In the present embodiment as well, as illustrated in FIG. 18A and FIG. 18B, it is possible to adopt a configuration including: a mixing valve 500 connected to a hot water supply pipe 510 and a cold water supply pipe 520 to generate hot water at a desired temperature; a first flow channel portion 110 connecting the mixing valve 500 and the first water discharge unit 100″; and a second flow channel portion 210 connecting the mixing valve 500 and the second water discharge unit 200″.

Further, in the present embodiment as well, the first flow channel portion 110 and the second flow channel portion 210 include the common portion 530 on the hot/cold water mixing valve 500 side, and branch at a branch (bifurcation) portion 550 (see FIG. 18A and FIG. 18B). Further, a plurality of the second water discharge units 200″ may be provided, and one or more second branch portions 215 may be provided between the plurality of second water discharge units 200″ and the branch portion 550. For example, as illustrated in FIG. 19, the second flow channel portion 210 spanning the plurality of second water discharge units 200″ can adopt a substantially T-shaped configuration in a plan view including one second branch portion 215.

Furthermore, in the present embodiment, the length of the second flow channel portion 210 extending from the hot/cold water mixing valve 500 to the second water discharge unit 200″ is longer than the length of the first flow channel portion 110 extending from the hot/cold water mixing valve 500 to the first water discharge unit 100″ (see FIG. 24 and FIG. 19).

### Actions and Effects of Eighth Embodiment

According to the eighth embodiment, substantially the same actions and effects as those achieved by the sixth and seventh embodiments can be achieved. That is, since the temperature of the hot water reaching (landing in) the first discharge range corresponding to the neck of the user is lower than the temperature of the hot water reaching (landing in) the second discharge range below the first discharge range, it is possible to provide a shower device suitable for use during a midday break. In addition, the feature wherein the temperature of the hot water reaching (landing in) the first discharge range corresponding to the neck of the user is relatively lower results in the state that the hot water of the relatively lower temperature reaches the neck (where thick arteries run) and the back immediately below the neck (where more perspiration may generally occur), thereby suppressing perspiration. On the other hand, by the feature wherein the temperature of the hot water reaching (landing in) the second discharge range below the first discharge range is relatively high, the user can be provided with a comfortable heating effect. That is, it is possible to provide a shower device that can both suppress perspiration and warm the body, and that is suitable for use during a midday break.

Further, the first water discharge unit 100″ and the second water discharge unit 200″ arc disposed facing each other with the predetermined position 300 being located therebetween, that is, the second discharge range tends to be toward a part of the body where thermal sensitivity is relatively low (in particular, the front side of the body). Therefore, the user can more reliably experience warming of the body. Further, the first water discharge unit 100″ and the second water discharge unit 200″ are disposed at substantially the same height position, and the discharge center direction of the first water discharge unit 100″ has a gentler downward angle than the discharge center direction of the second water discharge unit 200″. Therefore, the hot water from the first water discharge unit 100″ is readily locally discharged toward the first discharge range corresponding to the neck of the user, while the hot water from the second water discharge unit 200″ is discharged readily spread-out toward the second discharge range below the first discharge range more widely than the water discharged from the first water discharge unit 100″. Therefore, the hot water can be caused to land across a wider area of the body of the user, and the user can more reliably experience the warming of the body. Further, even when a high temperature is erroneously set, it is possible to promote a temperature drop of the discharged hot water from the second water discharge unit 200″ in the air.

Further, the length of the second flow channel portion 210 extending from the mixing valve 500 to the second water discharge unit 200″ is longer than the length of the first flow channel portion 110 extending from the mixing valve 500 to the first water discharge unit 100″. Thus, even if a high temperature is erroneously set, the temperature of the discharged hot water not subjected to the actions of the fan device 600 after having been discharged from the second water discharge unit 200″ is expected to drop, which can reduce the risk of the user getting burned (expected are a temperature drop due to a thermal conduction (heat dissipation) effect of the longer second flow channel portion 210 itself as well as a temperature drop due to residual hot water (whose temperature tends to be lower) remaining in the longer second flow channel portion 210). Specifically, when hot water is started to be supplied in a setting in which the temperature thereof is 50° C., as long as the temperature of the residual hot water is about 25° C. (about room temperature), the temperature of the hot water immediately after having been discharged from the second water discharge unit 200″ is dropped to about 40° C. even if the temperature of the hot water immediately after having been discharged from the first water discharge unit 100″ is as high as about 44° C.

### Configuration of Ninth Embodiment

Next, a shower device according to a ninth embodiment of the present invention will be described with reference to the accompanying drawings.

FIG. 5 explained above is also a perspective view illustrating a state in which the shower device according to the ninth embodiment of the present invention is installed in a shower room. That is, FIG. 5 is also an enlarged cross-sectional view illustrating a shower head main body of the shower device according to the ninth embodiment of the present invention.

As illustrated in FIG. 5, the shower device 1 of the present embodiment is fixed to the sidewall surface 2a of the shower room 2. Further, the shower device 1 includes the shower head main body 4 and the support member 6 for attaching the shower head main body 4 to the sidewall surface 2a.

The shower head main body 4 is an annular member having an elliptical shape. A plurality of spraying portions are provided at intervals along the annular member having the elliptical shape.

The support member 6 is a member attached on an upper part of the sidewall surface 2a so as to extend substantially horizontally therefrom, and is configured to support the shower head main body 4 at a predetermined height. Furthermore, a water supply channel (not illustrated) is provided inside the support member 6 in such a manner that hot water supplied through this water supply channel flows into the shower head main body 4 and is discharged from the plurality of spraying portions.

In the present embodiment, the shower head main body 4 is fixed to the sidewall surface 2a via the support member 6 extending substantially horizontally therefrom. However, the shower head main body may be fixed to the ceiling surface via a support member extending (suspended) from the ceiling surface. Further, the shower head main body may be directly fixed to the sidewall surface or the ceiling surface without the use of a support member.

The shower device 1 is configured such that, during use, the hot water is discharged from the plurality of spraying portions and thus a user standing below the shower head main body 4 is showered with the discharged hot water from above. Herein, since the plurality of spraying portions are provided along the annular shower head main body 4, the hot water discharged therefrom forms a shower so as to surround the head of the user standing below the shower head main body 4.

Next, an internal structure of the shower head main body 4 will be described with reference to FIG. 6 explained above.

As described above, the shower head main body 4 is formed in an annular configuration having an elliptical shape. A water supply passageway 4a extending along the annular configuration is provided inside the shower head main body 4. The hot water supplied through the water supply channel (not illustrated) formed inside the support member 6 flows into the water supply passageway 4a in the shower head main body 4 to be supplied to the entire shower

Furthermore, the shower head main body 4 is provided with a plurality of sprayer attachment recessed portions 4b at predetermined intervals along the water supply passageway 4a. Each of the sprayer attachment recessed portions 4b is a recess having a hollow cylindrical shape extending in the vertical direction, is formed so as to be in communication with the water supply passageway 4a, and is open toward the lower surface of the shower head main body 4. That is, the hot water flowing through the water supply passageway 4a of the shower head main body 4 flows into the sprayer attachment recessed portions 4b.

A sprayer holding member 8 is fitted in each of the sprayer attachment recessed portions 4b. The sprayer holding member 8 is a member having a substantially solid cylindrical shape and is watertightly fitted in each of the sprayer attachment recessed portions 4b.

A nozzle 18 serving as the spraying portion or the sprayer is held in the sprayer holding member 8, which forms the first water discharge unit of the present invention. The nozzle 18 is held by the sprayer holding member 8 in such a manner that the hot water in a mist form is discharged from a bottom surface of the sprayer holding member 8. Further, the nozzle 18 is held in an obliquely downward orientation by the sprayer holding member 8, and the nozzle 18 is configured to discharge the hot water obliquely downward toward a center axis of the shower head main body 4 having the elliptical shape.

FIG. 7 to FIG. 9 are views illustrating an example of the nozzle 18 for realizing a shower in a mist form, in which hot water falls while being spread out. FIG. 7 is a perspective view illustrating the entire nozzle. FIG. 8 is a partially enlarged cross-sectional view taken along line VIII-VIII of FIG. 7, and FIG. 9 is a partially enlarged cross-sectional view taken along line IX-IX of FIG. 7.

As illustrated in FIG. 7, the nozzle 18 serving as the spraying portion or the sprayer is formed in a substantially cylindrical shape and can be used by being fitted in each of the sprayer attachment recessed portions 4b of the shower head main body 4. As illustrated in FIG. 7 to FIG. 9, a passageway 18a having a circular cross section is formed along a center axis of the cylindrical-shaped nozzle 18. An inner wall surface 18b having a dome shape (hemispherical shape) is formed at an end of the passageway 18a having the circular cross section. Furthermore, a groove 18c having a V-shaped cross section is formed in an end surface of the nozzle 18, and a deepest portion of the groove 18c is formed by cutting out a part of the dome-shaped inner wall surface 18b.

According to this configuration, the hot water guided by the water supply passageway 4a in the shower head main body 4 flows into the passageway 18a of the nozzle 18, and the hot water guided by the passageway 18a flows out from a notch (the cut-out part) of the inner wall surface 18b to a bottom of the groove 18c having the V-shaped cross section, and then the hot water is discharged downward (upward in FIG. 7 to FIG. 9). As a result, as illustrated in FIG. 8, the hot water W discharged from the nozzle 18 falls while being spread out in a mist form in a cone or an elliptical cone shape. In the present embodiment, each nozzle 18 is attached to the shower head main body 4 in such a manner that a major axis of the elliptical cone shape is oriented in a tangential direction of the annular shower head main body 4 having the elliptical shape. Although the shower head main body 4 is provided with the spraying portions (sprayers) by attaching the nozzles 18 to the shower head main body 4 in the present embodiment, it is also possible to provide the shower head main body 4 with the spraying portions (sprayers) by directly forming nozzle holes in a member constituting the shower head main body 4.

In addition, a fluid element 10 serving as the spraying portion or the sprayer is held in the sprayer holding member 8, which forms the second water discharge unit of the present invention. The fluid element 10 is held by the sprayer holding member 8 in such a manner that hot water in a wave form is discharged from the bottom surface of the sprayer holding member 8. Further, the fluid element 10 is held in an obliquely downward orientation by the sprayer holding member 8, and the fluid element 10 is configured to discharge the hot water obliquely downward toward the center axis of the shower head main body 4 having the elliptical shape.

FIG. 10 to FIG. 12 are views illustrating an example of the fluid element 10 for realizing a shower in a wave form, in which hot water falls while being spread out. FIG. 10 is a perspective view of the fluid element 10. FIG. 11 is a cross-sectional view taken along line XI-XI in FIG. 10, and FIG. 12 is a cross-sectional view taken along line XII-XII in FIG. 10.

As illustrated in FIG. 10, the fluid element 10 is a generally thin rectangular parallelepiped member. A water discharge port 10a having a rectangular shape is provided at an end surface on a front surface side of the fluid element 10, and a flange portion 10b is formed at an end portion on a back surface side of the fluid element 10. Furthermore, a groove 10c is formed in parallel with the flange portion 10b, circling around the fluid element 10. An O-ring (not illustrated) is fitted in the groove 10c so as to ensure watertightness with the sprayer holding member 8.

As illustrated in FIG. 11, a passageway having a rectangular cross section is formed inside the fluid element 10, extending through the fluid element 10 in a longitudinal direction. The passageway is formed as a water supply passageway 12a, a vortex street passageway 12b, and a rectification passageway 12c, in this order from an upstream side.

The water supply passageway 12a is a linear passageway extending from an inflow port 10d on the back surface side of the fluid element 10 and having a rectangular cross section with a constant cross-sectional area.

The vortex street passageway 12b is a passageway having a rectangular cross section provided downstream of the water supply passageway 12a so as to be continuous with the water supply passageway 12a (without a step). That is, a downstream end of the water supply passageway 12a and an upstream end of the vortex street passageway 12b have the same size and shape. A pair of opposite wall surfaces (both sidewall surfaces) of the vortex street passageway 12b are configured to be tapered in such a manner that a flow channel cross-sectional area thereof is reduced toward the downstream side over the entire vortex street passageway 12b. That is, the vortex street passageway 12b is configured to have a width that gradually decreases toward the downstream side.

The rectification passageway 12c is a passageway having a rectangular cross section provided on the downstream side so as to be in communication with the vortex street passageway 12b, and is formed linearly with a constant cross-sectional area. The hot water including a vortex street guided by the vortex street passageway 12b is rectified by the rectification passageway 12c, and then is discharged from the water discharge port 10a. A flow channel cross-sectional area of the rectification passageway 12c is configured to be smaller than a flow channel cross-sectional area at a downstream end portion of the vortex street passageway 12b, and thus there is a step portion 14 formed between the vortex street passageway 12b and the rectification passageway 12c. A step portion wall surface that is a front surface of the step portion 14 is oriented in a direction orthogonal to a center axis of the vortex street passageway 12b.

On the other hand, as illustrated in FIG. 12, opposite wall surfaces (ceiling surface and floor surface) of the water supply passageway 12a, the vortex street passageway 12b, and the rectification passageway 12c in a height direction are all provided on the same plane. That is, heights of the water supply passageway 12a, the vortex street passageway 12b, and the rectification passageway 12c are all the same and constant.

Next, a hot water collision portion 16 is formed at a downstream end portion of the water supply passageway 12a (in the vicinity of a connecting portion between the water supply passageway 12a and the vortex street passageway 12b). The hot water collision portion 16 is provided so as to block a part of the water supply passageway 12a at the flow channel cross section. The hot water collision portion 16 is a portion having a triangular prism shape extending so as to couple the opposite wall surfaces (ceiling surface and floor surface) of the water supply passageway 12a facing each other in the height direction and is disposed like an island at the middle of the water supply passageway 12a in a width direction. A cross section of the hot water collision portion 16 is formed in an isosceles triangle shape, whose oblique side is disposed orthogonal to the center axis of the water supply passageway 12a and whose vertex is disposed facing the downstream side.

Since the hot water collision portion 16 is provided, a Karman vortex is generated on the downstream side thereof, which causes the hot water discharged from the water discharge port 10a to vibrate in a reciprocating manner. That is, the hot water supplied from the water supply channel (not illustrated) of the support member 6 flows into the water supply passageway 4a(FIG. 6) in the shower head main body 4, and further flows into the inflow port 10d of each fluid element 10 held by the corresponding sprayer holding member 8. Then, the hot water flows from the inflow port 10d of each fluid element 10 into the water supply passageway 12a and collides with the hot water collision portion 16 provided so as to block a part of the flow channel thereof. As a result, a vortex street of alternately counter-rotating Karman vortices is formed on the downstream side of the hot water collision portion 16. The Karman vortex formed by the hot water collision portion 16 grows while being guided by the vortex street passageway 12b tapered toward the downstream, and reaches the rectification passageway 12c.

The hot water flowing into the rectification passageway 12c located downstream of the vortex street passageway 12b is rectified here. The hot water discharged from the water discharge port 10a after having been flown through the rectification passageway 12c is curved on the basis of a flow velocity distribution at the water discharge port 10a, and thus a discharge direction is changed as a portion of the hot water having a high flow velocity moves in the vertical direction in FIG. 11. That is, when a portion of the hot water having a high flow velocity is located at an upper end of the water discharge port 10a in FIG. 11, the hot water is sprayed downward and, while when a portion of the hot water having a high flow velocity is located at a lower end of the water discharge port 10a, the hot water is sprayed upward. In this way, as the Karman vortices are alternately generated downstream of the hot water collision portion 16, such a flow velocity distribution is generated at the water discharge port 10a, and thus the sprayed (discharged) flow is deflected. Further, a position of the portion having a high flow velocity moves in a reciprocating manner as the vortex street progresses. Thus, the sprayed hot water also vibrates in a reciprocating manner in a sinusoidal wave shape (in a wave form) substantially within a predetermined vibration plane (plane parallel to the paper surface of FIG. 11).

As illustrated in FIG. 6, in the present embodiment, each fluid element 10 is attached in an obliquely downward orientation, and the hot water discharged from the water discharge port 10a of the fluid element 10 falls while being spread out in a fan-like shape substantially within a predetermined vibration plane. Herein, in the present embodiment, each fluid element 10 is attached to the shower head main body 4 in such a manner that the vibration plane thereof is oriented in the tangential direction (circumferential direction) of the annular shower head main body 4 having the elliptical shape. As a result, as a whole, a shower of hot water like a tubular shape with an elliptical cross section is formed below the shower head main body 4, and the head of the user standing below the shower head main body 4 is surrounded by the shower of hot water.

Further, in the ninth embodiment as well, the first flow channel portion 110 and the second flow channel portion 210 include a common portion on the mixing valve 500 (hot/cold water mixing unit) side, and branch at a branch portion 550.

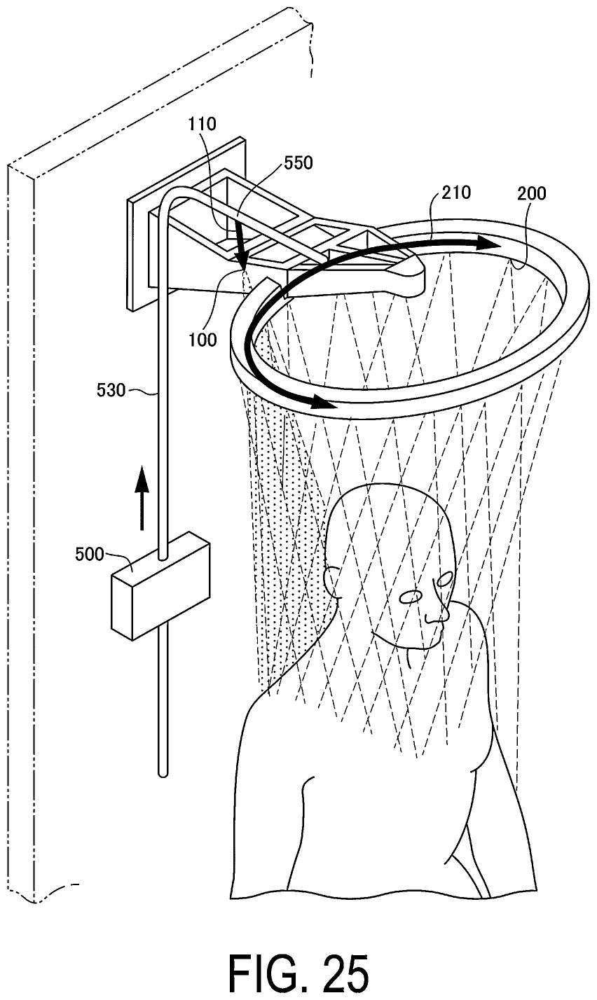

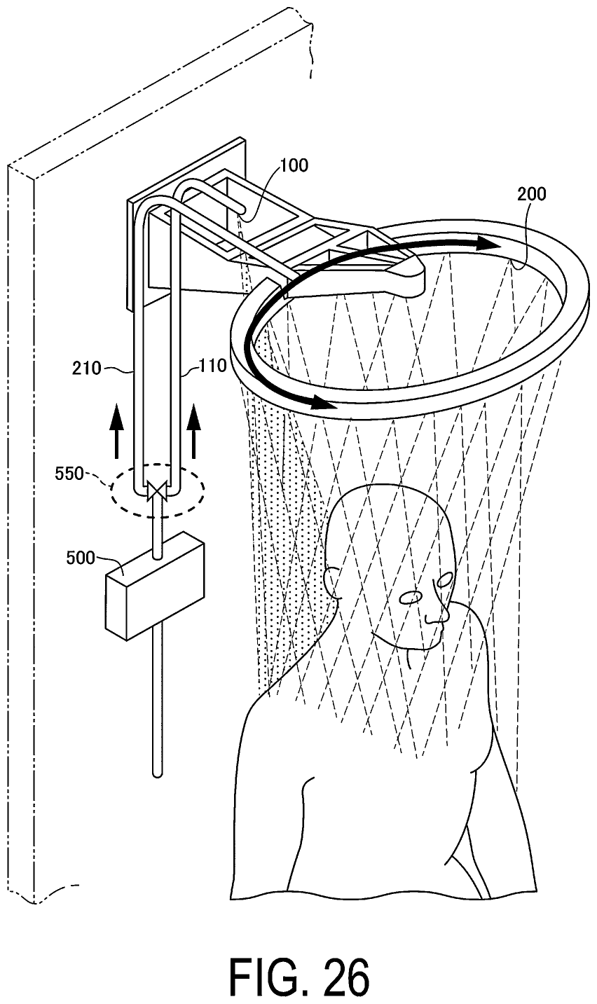

The branch portion 550 may be disposed in a region in the vicinity of the first water discharge unit 100 as illustrated in FIG. 25 or may be disposed in a region in the vicinity of the mixing valve 500 as illustrated in FIG. 26.

### Operations of Ninth Embodiment

Next, an operation of the shower device 1 according to the ninth embodiment of the present invention will be described with reference to FIG. 13.

FIG. 13 is also a view schematically illustrating a user taking a shower discharged from the shower head main body 4 of the shower device 1 according to the ninth embodiment of the present invention.

As described above, the hot water discharged from the nozzles 18 (first water discharge unit) provided in the shower head main body 4 is discharged in a mist form. On the other hand, the hot water discharged from the fluid elements 10 (second water discharge unit) provided in the shower head main body 4 is discharged in a wave form while vibrating in a reciprocating manner in a sinusoidal wave shape. As a result, as illustrated in FIG. 13, the hot water discharged from each nozzle 18 and each fluid element 10 falls while being spread out substantially in a fan-like shape. Further, as described above, each nozzle 18 and each fluid element 10 are attached in an obliquely downward orientation toward the center of the shower head main body 4 (FIG. 6). Therefore, a discharge space S surrounded by the shower of hot water from the respective nozzles 18 and the respective fluid elements 10 has a shape that is tapered downward.

Furthermore, the nozzles 18 and the fluid elements 10 are provided at predetermined intervals along the annular shower head main body 4. Therefore, as illustrated in FIG. 13, in a region where the width of the hot water discharged from each nozzle 18 and each fluid element 10 is not sufficiently wide (region in the vicinity of the shower head main body 4), there are gaps between the hot water discharged from the nozzles 18 and the fluid element 10. This makes it possible for an air in the discharge space S surrounded by the hot water discharged from the nozzles 18 and the fluid elements 10 to flow outward of the discharge space S through the gaps between the discharged hot water. Further, in the present embodiment, since the shower head main body 4 is configured to have an annular shape, the air in the discharge space S is allowed to flow above the shower head main body 4 passing through the inside of the shower head main body 4. Therefore, hot air resulting from the discharged hot water does not stagnate in the discharge space S, and thus the discharge space S is maintained at a comfortable temperature.

On the other hand, the hot water discharged from each nozzle 18 and each fluid element 10 falls while being spread out in a horizontal direction, which causes the discharged hot water to form a flat fan-like shape. The hot water forming a fan-like shape discharged from each nozzle 18 and each fluid element 10 merges at a position where the hot water has fallen by a predetermined distance L. Further, since the hot water forming a flat fan-like shape discharged from each nozzle 18 and each fluid element 10 is directed in the tangential direction of the annular shower head main body 4, the head and the body of the user are surrounded by the hot water forming a fan-like shape discharged from each nozzle 18 and each fluid element 10, and a water film is formed around the body of the user. Therefore, a portion of the discharge space S above the position of the predetermined distance L downward from the shower head main body 4 acts as a hot air releasing space due to the gaps between the shower of hot water. A portion of the discharge space S below the position of the predetermined distance L downward from the shower head main body 4 serves as a hot air holding space due to the hot water discharged from each nozzle 18 and each fluid element 10 merging to form the water film surrounding the body.

Accordingly, the hot water discharged from each nozzle 18 and each fluid element 10 falls by the predetermined distance L, lands on an upper half of the body of the user, and forms a water film so as to cover the body. As a result, the body of the user is sufficiently warmed by the hot water. Therefore, even when the temperature in the shower room 2 is low, the user does not feel cold and can continue to take a shower for a long time.

According to the shower device of the ninth embodiment of the present invention, since the shower head main body 4 is fixed to the sidewall surface 2a, the user can take a shower without holding the shower head main body 4 with his/her hand. In addition, since the nozzles 18 and the fluid elements 10, which serve as the plurality of spraying portions, are provided at intervals in the shower head main body 4, there are gaps between the hot water discharged from each nozzle 18 and each fluid element 10 in the vicinity of the shower head main body 4. This makes it possible to suppress stagnation of hot air in the discharge space S surrounded by the discharged hot water. As a result, it is possible to help prevent the user from feeling hot or stuffy when the user takes a long shower. Further, since the hot water discharged from each nozzle 18 and each fluid element 10 falls while being spread out, the hot water lands on the body of the user standing below the shower head main body 4 across a wide area, and after landing, the hot water is further spread out on the body surface, making it possible to sufficiently wrap the body with the hot water. As a result, even in a state in which the air temperature is low, the user taking a shower is unlikely to feel cold and can continue taking a shower for a long time.

Further, according to the shower device of the present embodiment, the hot water discharged from each nozzle 18 and each fluid element 10 merges at the position where the hot water has fallen by the predetermined distance L from each nozzle 18 and each fluid element 10 (FIG. 13). Thus, it is possible to ensure air permeability inside and outside the discharge space S surrounded by the discharged hot water up to the position where the hot water merges, and to suppress stagnation of the hot air. Further, below the position where the discharged hot water merges, the body of the user can be sufficiently wrapped with the hot water and thus the body of the user can be sufficiently warmed.

Furthermore, according to the shower device of the present embodiment, since the discharge space S surrounded by the discharged hot water has a shape that is tapered downward, it is possible to ensure air permeability more sufficiently at an upper portion of the discharge space S surrounded by the hot water, while a lower portion of the discharge space S surrounded by the hot water has a smaller volume, which results in case to ensure heat retainability therein to warm the user sufficiently.

Further, according to the shower device of the present embodiment, since the shower head main body 4 has an annular shape, the air in the discharge space S surrounded by the discharged hot water is allowed to flow upward (outside) passing through the inside of the shower head main body 4, which can suppress stagnation of the hot air in the discharge space S surrounded by the discharged hot water.

Further, according to the shower device of the present embodiment, the length of the second flow channel portion 210 extending from the mixing valve 500 (hot/cold water mixing unit) to each fluid element 10 is longer than the length of the first flow channel portion 110 extending from the mixing valve 500 (hot/cold water mixing unit) to each nozzle 18. Thus, even if a high temperature is erroneously set, the temperature of the discharged hot water having a large particle size discharged from each fluid element 10 is expected to drop, which can reduce the risk of the user getting burned (expected are a temperature drop due to a thermal conduction (heat dissipation) effect of the longer second flow channel portion 210 itself as well as a temperature drop due to residual hot water (whose temperature tends to be lower) remaining in the longer second flow channel portion 210).

### Tenth Embodiment

Next, a shower device according to a tenth embodiment of the present invention will be described with reference to FIG. 14.

In the shower device of the present embodiment, the shape of the shower head main body differs from that of the ninth embodiment described above. Accordingly, the features of the tenth embodiment of the present invention that differ from those of the ninth embodiment will be described, and description of the similar configurations, actions, and effects will be omitted. FIG. 14 is also a perspective view illustrating a state in which a user is taking a shower with hot water discharged from the shower device according to the tenth embodiment of the present invention.

As illustrated in FIG. 14, a shower head main body 20 provided in the shower device according to the tenth embodiment of the present invention is formed in an annular configuration having a rectangular shape. A plurality of spraying portions are provided along the annular shower head main body 20 having the rectangular shape to form a shower so as to surround the head of the user. The hot water discharged from each spraying portion falls while being spread out in a flat fan-like shape. Further, the hot water falling while being spread out in a fan-like shape is directed in a direction that maintains a parallel relationship with each corresponding side of the shower head main body 20, and merges at a position where the hot water has fallen by a predetermined distance from each spraying portion, and forms a water film around the body of the user. Furthermore, each spraying portion is attached in an obliquely downward orientation in such a manner that the discharged hot water is directed toward the center of the shower head main body 20, and the discharge space surrounded by the shower of hot water has a shape that is tapered downward in a square pyramid. Herein, the nozzle illustrated in FIG. 7 and the fluid element illustrated in FIG. 10 may be employed in an appropriate arrangement as the plurality of spraying portions provided in the shower head main body 20.

Further, according to the shower device of the present embodiment as well, the length of the second flow channel portion 210 extending from the mixing valve 500 (hot/cold water mixing unit) to each fluid element 10 is longer than the length of the first flow channel portion 110 extending from the mixing valve 500 (hot/cold water mixing unit) to each nozzle 18. Thus, even if a high temperature is erroneously set, the temperature of the discharged hot water having a large particle size discharged from each fluid element 10 is expected to drop, which can reduce the risk of the user getting burned (expected are a temperature drop due to a thermal conduction (heat dissipation) effect of the longer second flow channel portion 210 itself as well as a temperature drop due to residual hot water (whose temperature tends to be lower) remaining in the longer second flow channel portion 210).

### Eleventh Embodiment

Next, a shower device according to an eleventh embodiment of the present invention will be described with reference to FIG. 15.

In the shower device of the present embodiment, the shape of the shower head main body differs from that of the ninth embodiment described above. Accordingly, the features of the eleventh embodiment of the present invention that differ from those of the ninth embodiment will be described, and description of the similar configurations, actions, and effects will be omitted. FIG. 15 is a perspective view illustrating a state in which a user is taking a shower with hot water discharged from the shower device according to the eleventh embodiment of the present invention.

As illustrated in FIG. 15, a shower head main body 30 provided in the shower device according to the eleventh embodiment of the present invention consists of two shower head main bodies 30a, 30b, each of which is formed in a linear shape. A plurality of spraying portions are provided along each of the linear shower head main bodies 30a, 30b to form a shower so as to surround the head of the user. The hot water discharged from each spraying portion falls while being spread out in a flat fan-like shape. Furthermore, the spraying portions provided in a middle region of each of the linear shower head main bodies 30a, 30b discharge hot water in a fan-like shape in a direction that maintains a parallel relationship with an extending direction of each of the linear shower head main bodies 30a, 30b. In contrast, the spraying portions provided in the vicinity of both end portions of each of the linear shower head main bodies 30a, 30b discharge hot water in a fan-like shape in a direction substantially at a right angle with respect to the extending direction of each of the linear shower head main bodies 30a, 30b.

Furthermore, the spraying portions provided in each of the linear shower head main bodies 30a, 30b discharge hot water obliquely downward in such a manner that the discharged hot water comes close to each other. Therefore, the discharge space surrounded by the discharged hot water has a shape that is tapered downward. Further, the hot water discharged from each spraying portion provided in the vicinity of the end portions of the shower head main bodies 30a and 30b is directed so as to merge at a position where the hot water has fallen by a predetermined distance. Therefore, as a whole, the hot water discharged from the spraying portions of the two linear shower head main bodies 30a, 30b forms a shower so as to surround the head of the user standing between the two linear shower head main bodies 30a, 30b. Herein, the nozzle exemplified in FIG. 7 and the fluid element exemplified in FIG. 10 may be employed in an appropriate arrangement as the plurality of spraying portions provided in the shower head main body 30.

Further, according to the shower device of the present embodiment as well, the length of the second flow channel portion 210 extending from the mixing valve 500 (hot/cold water mixing unit) to each fluid element 10 is longer than the length of the first flow channel portion 110 extending from the mixing valve 500 (hot/cold water mixing unit) to each nozzle 18. Thus, even if a high temperature is erroneously set, the temperature of the discharged hot water having a large particle size discharged from each fluid element 10 is expected to drop, which can reduce the risk of the user getting burned (expected are a temperature drop due to a thermal conduction (heat dissipation) effect of the longer second flow channel portion 210 itself as well as a temperature drop due to residual hot water (whose temperature tends to be lower) remaining in the longer second flow channel portion 210).

### Twelfth Embodiment

Next, a shower device according to a twelfth embodiment of the present invention will be described with reference to FIG. 16.

In the shower device of the present embodiment, the shape of the shower head main body differs from that of the ninth embodiment described above. Accordingly, the features of the twelfth embodiment of the present invention that differ from those of the ninth embodiment will be described, and description of the similar configurations, actions, and effects will be omitted. FIG. 16 is a perspective view illustrating a state in which a user is taking a shower with hot water discharged from the shower device according to the twelfth embodiment of the present invention.

As illustrated in FIG. 16, a shower head main body 40 provided in the shower device according to the twelfth embodiment of the present invention consists of two shower head main bodies 40a, 40b, each of which is formed in a curved manner. The shower head main bodies 40a, 40b extend in such a curved manner that opposite end portions thereof come close to each other, and a plurality of spraying portions are provided along each of the curved shower head main bodies 40a, 40b. These spraying portions form a shower so as to surround the head of the user. Here, the hot water discharged from each spraying portion falls while being spread out in a flat fan-like shape. Furthermore, the spraying portions provided in a middle region of each of the curved shower head main bodies 40a, 40b discharge hot water in a fan-like shape in a tangential direction of the curved direction of each of the shower head main bodies 40a, 40b. In contrast, the spraying portions provided in the vicinity of both end portions of each of the curved shower head main bodies 40a, 40b discharge hot water in a fan-like shape at angles close to a right angle with respect to the curved direction of each of the shower head main bodies 40a, 40b.

Furthermore, the spraying portions provided in each of the curved shower head main bodies 40a, 40b discharge hot water obliquely downward in such a manner that the discharged hot water comes close to each other. Therefore, the discharge space surrounded by the discharged hot water has a shape that is tapered downward. Further, the hot water discharged from each spraying portion provided in the vicinity of the end portions of the shower head main bodies 40a and 40b is directed so as to merge at a position where the hot water has fallen by a predetermined distance. Therefore, as a whole. the hot water discharged from the spraying portions of the two curved shower head main bodies 40a, 40b forms a shower so as to surround the head of the user standing between the two curved shower head main bodies 40a, 40b. Herein, the nozzle exemplified in FIG. 7 and the fluid element exemplified in FIG. 10 may be employed in an appropriate arrangement as the plurality of spraying portions provided in the shower head main body 40.

Further, according to the shower device of the present embodiment as well, the length of the second flow channel portion 210 extending from the mixing valve 500 (hot/cold water mixing unit) to each fluid element 10 is longer than the length of the first flow channel portion 110 extending from the mixing valve 500 (hot/cold water mixing unit) to each nozzle 18. Thus, even if a high temperature is erroneously set, the temperature of the discharged hot water having a large particle size discharged from each fluid element 10 is expected to drop, which can reduce the risk of the user getting burned (expected are a temperature drop due to a thermal conduction (heat dissipation) effect of the longer second flow channel portion 210 itself as well as a temperature drop due to residual hot water (whose temperature tends to be lower) remaining in the longer second flow channel portion 210).

Note that the present invention includes the following features (inventions).

### Feature 1

A water discharge device including:
a hot/cold water mixing unit configured to generate hot water of a desired temperature by mixing hot water of a high temperature and cold water;
a first water discharge unit configured to discharge hot water toward a user who is to be at a predetermined position;
a second water discharge unit provided separately from the first water discharge unit and configured to discharge hot water toward the user who is to be at the predetermined position;
a first flow channel portion extending from the hot/cold water mixing unit to the first water discharge unit; and
a second flow channel portion extending from the hot/cold water mixing unit to the second water discharge unit, wherein
a particle size of the hot water discharged from the second water discharge unit after having been flown through the second flow channel portion is larger than a particle size of the hot water discharged from the first water discharge unit after having been flown through the first flow channel portion, and
a length of the second flow channel portion is longer than a length of the first flow channel portion.

### Feature 2

A water discharge device including:
a hot/cold water mixing unit configured to generate hot water of a desired temperature by mixing hot water of a high temperature and cold water;
a first water discharge unit configured to discharge hot water toward a user who is to be at a predetermined position;
a second water discharge unit provided separately from the first water discharge unit and configured to discharge hot water toward the user who is to be at the predetermined position; a first flow channel portion extending from the hot/cold water mixing unit to the first water discharge unit; and
a second flow channel portion extending from the hot/cold water mixing unit to the second water discharge unit, wherein
the first flow channel portion and the second flow channel portion branch off from a branch portion provided downstream of the hot/cold water mixing unit,
a flow velocity of the hot water discharged from the second water discharge unit after having been flown though the second flow channel portion is slower than a flow velocity of the hot water discharged from the first water discharge unit after having been flown through the first flow channel portion, and
a length of the second flow channel portion is longer than a length of the first flow channel portion.

### Feature 3

A water discharge device including:
a hot/cold water mixing unit configured to generate hot water of a desired temperature by mixing hot water of a high temperature and cold water;
a first water discharge unit configured to discharge hot water toward a user who is to be at a predetermined position;
a second water discharge unit provided separately from the first water discharge unit and configured to discharge hot water toward the user who is to be at the predetermined position;
a first flow channel portion extending from the hot/cold water mixing unit to the first water discharge unit;
a second flow channel portion extending from the hot/cold water mixing unit to the second water discharge unit; and
a temperature lowering device provided to actively lower a temperature of the hot water discharged from the first water discharge unit after having been flown through the first flow channel portion, wherein
the first flow channel portion and the second flow channel portion branch off from a branch portion provided downstream of the hot/cold water mixing unit, and
a length of the second flow channel portion is longer than a length of the first flow channel portion.

### Feature 4

The water discharge device according to any one of features 1 to 3, wherein
the first water discharge unit and the second water discharge unit are disposed facing each other with the predetermined position being located between the first water discharge unit and the second water discharge unit, and
a discharge range by the second water discharge unit is below a discharge range by the first water discharge unit.

### Feature 5

The water discharge device according to any one of features 1 to 4, wherein
the first water discharge unit is configured to discharge the hot water in a mist form.

### Feature 6

The water discharge device according to any one of features 1 to 5, wherein
an angle formed by a discharge center direction of the first water discharge unit with respect to a vertical direction is larger than an angle formed by a discharge center direction of the second water discharge unit with respect to the vertical direction.

### Feature 7

The water discharge device according to any one of features 1 to 6, wherein
a plurality of the second water discharge units are provided, and
one or a plurality of second branch portions are provided between the plurality of second water discharge units and the branch portion.

### REFERENCE SIGNS LIST

1 Shower device
2 Shower room
2a Sidewall surface
4 Shower head main body
4a Water supply passageway
4b Sprayer attachment recessed portion
6 Support member
8 Sprayer holding member
10 Fluid element (sprayer)
10a Water discharge port
10b Flange portion
10c Groove
10d Inflow port
12a Water supply passageway
12b Vortex street passageway
12c Rectification passageway
14 Step portion
16 Hot water collision portion
18 Nozzle
18a Passageway
18b Inner wall surface
18c Groove
20 Shower head main body
30 Shower head main body
30a Shower head main body
30b Shower head main body
40 Shower head main body
40a Shower head main body
40b Shower head main body
100, 100′, 100″ First water discharge unit
110 First flow channel portion
200, 200′, 200″ Second water discharge unit
210 Second flow channel portion
215, 215′, 216, 216′, 217, 218 Second branch portion
300 Predetermined position
400 Operation unit
500 Mixing valve
510 Hot water supply pipe
520 Cold water supply pipe
530 Common flow channel portion
550 Branch portion
600 Fan device

1. A water discharge device comprising:
a first water discharge unit configured to discharge hot water toward a first discharge range corresponding to a neck of a user who is to be at a predetermined position; and
a second water discharge unit configured to discharge hot water toward a second discharge range to the user below the first discharge range, wherein
a temperature of the hot water when the hot water reaches the user after having been discharged from the first water discharge unit is lower than a temperature of the hot water when the hot water reaches the user after having been discharged from the second water discharge unit.

2. The water discharge device according to claim 1, wherein
the first discharge range is configured to be variably set to accommodate a height of the user.

3. The water discharge device according to claim 1, wherein
the first water discharge unit and the second water discharge unit are disposed facing each other with the predetermined position being located between the first water discharge unit and the second water discharge unit.

4. The water discharge device according to claim 1, wherein
the first water discharge unit and the second water discharge unit are configured to discharge hot water such that the hot water is spread out.

5. The water discharge device according to claim 1, wherein
an angle formed by a discharge center direction of the first water discharge unit with respect to a vertical direction is larger than an angle formed by a discharge center direction of the second water discharge unit with respect to the vertical direction.

6. The water discharge device according to claim 1, wherein
the second water discharge unit is configured to discharge the hot water toward a front side, a left side and a right side of the user.

7. The water discharge device according to claim 1, further comprising:
an operation unit configured to perform an operational input to the first water discharge unit and/or the second water discharge unit, wherein
the first water discharge unit and the operation unit are disposed facing each other with the predetermined position being located between the first water discharge unit and the operation unit.

8. The water discharge device according to claim 1, further comprising:
a mixing valve connected to a cold water supply pipe and a hot water supply pipe to generate the hot water;
a first flow channel portion connecting the mixing valve and the first water discharge unit; and
a second flow channel portion connecting the mixing valve and the second water discharge unit, wherein
a particle size of the hot water discharged from the first water discharge unit after having been flown through the first flow channel portion is smaller than a particle size of the hot water discharged from the second water discharge unit after having been flown through the second flow channel portion.

9. The water discharge device according to claim 1, further comprising:
a mixing valve connected to a cold water supply pipe and a hot water supply pipe to generate the hot water;
a first flow channel portion connecting the mixing valve and the first water discharge unit; and
a second flow channel portion connecting the mixing valve and the second water discharge unit, wherein
the first flow channel portion and the second flow channel portion branch off from a branch portion provided downstream of the mixing valve,
a particle size of the hot water discharged from the second water discharge unit after having been flown through the second flow channel portion is larger than a particle size of the hot water discharged from the first water discharge unit after having been flown through the first flow channel portion, and
a length of the second flow channel portion is longer than a length of the first flow channel portion.

10. The water discharge device according to claim 1, further comprising:
a mixing valve connected to a cold water supply pipe and a hot water supply pipe to generate the hot water;
a first flow channel portion connecting the mixing valve and the first water discharge unit; and
a second flow channel portion connecting the mixing valve and the second water discharge unit, wherein
the first flow channel portion and the second flow channel portion branch off from a branch portion provided downstream of the mixing valve,
a flow velocity of the hot water discharged from the second water discharge unit after having been flown through the second flow channel portion is slower than a flow velocity of the hot water discharged from the first water discharge unit after having been flown through the first flow channel portion, and
a length of the second flow channel portion is longer than a length of the first flow channel portion.

11. The water discharge device according to claim 1, further comprising:
a mixing valve connected to a cold water supply pipe and a hot water supply pipe to generate the hot water;
a first flow channel portion connecting the mixing valve and the first water discharge unit;
a second flow channel portion connecting the mixing valve and the second water discharge unit; and
a temperature lowering device provided to actively lower a temperature of the hot water discharged from the first water discharge unit after having been flown through the first flow channel portion, wherein
the first flow channel portion and the second flow channel portion branch off from a branch portion provided downstream of the mixing valve, and
a length of the second flow channel portion is longer than a length of the first flow channel portion.

12. The water discharge device according to claim 8, wherein
the first water discharge unit is configured to discharge the hot water in a mist form.

13. The water discharge device according to claim 8, wherein
a plurality of the second water discharge units are provided, and
one or a plurality of second branch portions are provided between the plurality of second water discharge units and the branch portion.
